(19) United States
(12) Patent Application Publication
(10) Pub. No.: US 2014/0213745 A1
(43) Pub. Date: Jul. 31, 2014

(54) Branched Propylene Oligomers

(71) Applicant: ExxonMobil Chemical Patents Inc., Baytown, TX (US)

(72) Inventors: Peijun Jiang, League City, TX (US); Charles J. Ruff, Houston, TX (US)

(21) Appl. No.: 14/158,050

(22) Filed: Jan. 17, 2014

Related U.S. Application Data
(60) Provisional application No. 61/758,608, filed on Jan. 30, 2013.

(51) Int. Cl. C08F 10/06

(52) U.S. Cl. CPC C08F 10/06
USPC 526/126; 526/348; 526/351

(57) ABSTRACT

This invention relates method to prepare and compositions pertaining to an amorphous polymer comprising: at least 95 mol % propylene and 0 to 5 mol % vinyl monomer content, wherein the polymer has a g′ᵥᵢₛ of less than 0.95, an Mₙ of about 200 to about 10,000, an ΔH_{f} of less than 10 J/g and has greater than 50% allylic chain end functionality.

### PRIORITY CLAIM

This application claims priority to and the benefit of U.S. Provisional Application No. 61/758,608, filed Jan. 30, 2013 and EP 13160936.4, filed Mar. 25, 2013.

### FIELD OF THE INVENTION

This invention relates to branched propylene oligomers with high levels (>90%) of vinyl chain end. The oligomers can be used as base stock for oil dispersant and other functionalized materials.

### BACKGROUND OF THE INVENTION

Alpha-olefins, especially those containing about 6 to about 20 carbon atoms, have been used as intermediates in the manufacture of detergents or other types of commercial products. Such alpha-olefins have also been used as monomers, especially in linear low density polyethylene. Commercially produced alpha-olefins are typically made by oligomerizing ethylene. Longer chain alpha-olefins, such as vinyl-terminated polyethylenes are also known and can be useful as building blocks following functionalization or as macromonomers.

Allyl terminated low molecular weight solids and liquids of ethylene or propylene have also been produced, typically for use as branches in polymerization reactions. See, for example, Rulhoff, Sascha, and Kaminsky, (“Synthesis and Characterization of Defined Branched Poly(propylene)s with Different Microstructures by Copolymerization of Propylene and Linear Ethylene Oligomers (Cₙ=26-28) with Metallocenes/MAO Catalysts,” Macromolecular Chemistry and Physics, 16, 2006, pp. 1450-1460), and Kaneyoshi, Hiromu et al. (“Synthesis of Block and Graft Copolymers with Linear Polyethylene Segments by Combination of Degenerative Transfer Coordination Polymerization and Atom Transfer Radical Polymerization,” Macromolecules, 38, 2005, pp. 5425-5435).

Further, U.S. Pat. No. 4,814,540 discloses bis(pentamethyl cyclopentadienyl) hafnium dichloride, bis(pentamethyl cyclopentadienyl) zirconium dichloride and bis(tetramethyl n-butyl cyclopentadienyl) hafnium dichloride with methylalumoxane in toluene or hexane with or without hydrogen to make allylic vinyl terminated propylene homo-oligomers having a low degree of polymerization of 2-10. These oligomers do not have high Mn's and do not have at least 93% allylic vinyl unsaturation. Likewise, these oligomers lack comonomer and are produced at low productivities with a large excess of alumoxane (molar ratio≧600 Al/M; M=Zr, Hf). Additionally, no less than 60 wt % solvent (solvent+propylene basis) is present in all of the examples.

Teuben et al. (J. Mol. Catal., 62, 1990, pp. 277-287) disclose the use of [Cp*₂MMe(THT)]+[BPh₄] (M=Zr and Hf; Cp*=pentamethylcyclopentadienyl; Me=methyl, Ph=phenyl; THT=tetrahydrothiophene), to make propylene oligomers. For M=Zr, a broad product distribution with oligomers up to C₂₄ (number average molecular weight (Mn) of 336) was obtained at room temperature. Whereas, for M=Hf, only the dimer 4-methyl-1-pentene and the trimer 4,6-dimethyl-1-heptene were formed. The dominant termination mechanism appeared to be beta-methyl transfer from the growing chain back to the metal center, as was demonstrated by deuterium labeling studies.

X. Yang et al. (Angew. Chem. Intl Ed. Engl., 31, 1992, pp. 1375-1377) disclose amorphous, low molecular weight polypropylene made at low temperatures where the reactions showed low activity and product having 90% allylic vinyls, relative to all unsaturations, by ¹H NMR. Thereafter, Resconi et al. (J. Am. Chem. Soc., 114, 1992, pp. 1025-1032), discloses the use of bis(pentamethylcyclopentadienyl)zirconium and bis(pentamethylcyclopentadienyl)hafnium to polymerize propylene and obtained beta-methyl termination resulting in oligomers and low molecular weight polymers with “mainly allyl- and iso-butyl-terminated” chains. As is the case in U.S. Pat. No. 4,814,540, the oligomers produced do not have at least 93% allyl chain ends, an Mn of about 500 to about 20,000 g/mol (as measured by ¹H NMR), and the catalyst has low productivity (1-12,620 g/mmol metallocene/hr; >3000 wppm Al in products).

Similarly, Small and Brookhart (Macromolecules, 32, 1999, pp. 2120-2130) disclose the use of a pyridylbisamido iron catalyst in a low temperature polymerization to produce low molecular weight amorphous propylene materials apparently having predominant or exclusive 2,1 chain growth, chain termination via beta-hydride elimination, and high amounts of vinyl end groups.

Weng et al. (Macromol Rapid Comm. 2000, 21, pp. 1103-1107) discloses materials with up to about 81 percent vinyl termination made using dimethylsilyl bis(2-methyl, 4-phenyl-indenyl) zirconium dichloride and methylalumoxane in toluene at about 120° C. The materials have a Mn of about 12,300 (measured with ¹H NMR) and a melting point of about 143° C.

Macromolecules, 33, 2000, pp. 8541-8548 discloses preparation of branch-block ethylene-butene polymer by reincorporation of vinyl terminated polyethylene, said branch-block polymer made by a combination of CP₂ZrCL₂ and (C₅Me₄SiMe₂NC₁₂H₂₃)TiCl₂ activated with methylalumoxane.

Moscardi et al. (Organometallics, 20, 2001, pp. 1918-1931) disclose the use of rac-dimethylsilylmethylenebis(3-t-butyl indenyl)zirconium dichloride with methylalumoxane in batch polymerizations of propylene to produce materials where “ . . . allyl end group always prevails over any other end groups, at any [propene].” In these reactions, morphology control was limited and approximately 60% of the chain ends are allylic.

Coates et al. (Macromolecules, 38, 2005, pp. 6259-6268) disclose preparation of low molecular weight syndiotactic polypropylene ([rrrr]=0.46-0.93) with about 100% allyl end groups using bis(phenoxyimine)titanium dichloride ((PHI)₂TiCl₂) activated with modified methyl alumoxane (MMAO; Al/Ti molar ratio=200) in batch polymerizations run between −20 and +20° C. for four hours. For these polymerizations, propylene was dissolved in toluene to create a 1.65 M toluene solution. Catalyst productivity was very low (0.95 to 1.14 g/mmol Ti/hr).

Japanese Publication No. JP 2005-336092 A2 discloses the manufacture of vinyl-terminated propylene polymers using materials such as H₂SO₄ treated montmorillonite, triethylaluminum, triisopropyl aluminum, where the liquid propylene is fed into a catalyst slurry in toluene. This process produces substantially isotactic macromonomers that do not have a significant amount of amorphous material.

Rose et al. (Macromolecules, 41, 2008, pp. 559-567) disclose poly(ethylene-co-propylene) macromonomers not having significant amounts of iso-butyl chain ends. Those were made with bis(phenoxyimine) titanium dichloride ((PHI)₂TiCl₂) activated with modified methylalumoxane (MMAO; Al/Ti molar ratio range 150 to 292) in semi-batch polymerizations (30 psi propylene added to toluene at 0° C. for 30 min, followed by ethylene gas flow at 32 psi of over-pressure at about 0° C. for polymerization times of 2.3 to 4 hours to produce E-P copolymer having an Mn of about 4,800 to 23,300. In four reported copolymerizations, allylic chain ends decreased with increasing ethylene incorporation roughly according to the equation:

% allylic chain ends (of total unsaturations)=−0.95(mol % ethylene incorporated)+100.

For example, 65% allyl (compared to total unsaturation) was reported for E-P copolymer containing 29 mol % of ethylene. This is the highest allyl population achieved. For 64 mol % incorporated ethylene, only 42% of the unsaturations are allylic. Productivity of these polymerizations ranged from 0.78×10² g/mmol Ti/hr to 4.62×10² g/mmol Ti/hr.

Prior to this work, Zhu et al. reported only low (˜38%) vinyl terminated ethylene-propylene copolymer made with the constrained geometry metallocene catalyst [C₅Me₄(SiMe₂N-tert-butyl)TiMe₂ activated with B(C₆F₅)₃ and MMAO (Macromolecules, 35, 2002, pp. 10062-10070 and Macromolecules Rap. Commun., 24, 2003, pp. 311-315).

Janiak and Blank summarize a variety of work related to oligomerization of olefins (Macromol. Symp., 236, 2006, pp. 14-22).

U.S. patent application Ser. No. 13/072,280, filed Mar. 25, 2011 published as U.S. Patent Application Publication No. 2012-0245311 A1 and PCT Publication No. WO 2012/134719 provides methods and catalysts to undertake olefin polymerization, particularly to produce vinyl terminated polymers.

Other references of interest include: U.S. Patent Application Ser. No. 61/601,729 filed Feb. 22, 2012; and U.S. patent application Ser. No. 13/629,323 filed Sep. 27, 2012.

U.S. Patent Application Ser. No. 61/467,681 filed Mar. 25, 2011, published on Sep. 27, 2012, discloses methods to prepare vinyl terminated macromonomers having branches.

Another reference of interest is Schobel, Lanzinger and Reiger in “Polymerization Behavior of C1-Symmetric Metallocenes (M=Zr, Hf): From Ultrahigh Molecular Weight Elastic Polypropylene to Useful Macromonomers” (OrganoMetallics, Jan. 15, 2013) which discloses propylene macromonomers containing vinyl groups used to make polyethylene-g-polypropylene copolymers.

However, few catalysts/processes have been shown to produce branched high allylic chain unsaturations in high yields, a wide range of molecular weight, and with high catalyst activity for propylene-based polymerizations. The physical properties of branched oligomer and polymers have attracted considerable attention. Branching in an oligomer or a polymer can result in solution and solid-state properties markedly different than those of its linear counterpart. Accordingly, there is need for new catalysts and/or processes that produce branched vinyl terminated polymers in high yields, with a wide range of molecular weight, and with high catalyst activity. Further, there is a need for propylene based reactive materials having vinyl termination and branched architecture which can be functionalized and used in additive applications, or as macromonomers for the synthesis of polyolefin.

### SUMMARY OF THE INVENTION

The invention relates to processes, preferably a homogenous processes, for making branched amorphous vinyl terminated propylene oligomers and polymers, and compositions comprising such branched amorphous propylene oligomers and polymers, wherein the process comprises contacting propylene with a catalyst system, comprising an activator and at least one metallocene compound. The branched amorphous propylene oligomers and polymers have at least 50% allyl chain ends relative to all unsaturated chain ends, and have a ratio of saturated chain ends to percentage of allyl chain ends of 1.1 or greater.

In one aspect, the branched vinyl terminated propylene polymer comprises at least 95 mol % propylene and 0-5 mol % other vinyl monomers, such as ethylene, butene and hexene, etc.

In another aspect, the branched vinyl terminated propylene polymer has a g′ᵥᵢₛ of less than 0.98, preferably less than 0.95, preferably less than 0.90, preferably less than 0.89, preferably less than 0.88, preferably less than 0.87, and preferably less than 0.86, preferably less than 0.85.

In still other aspects, the branched vinyl terminated propylene polymer has an Mₙ of from about 200 to about 10,000 g/mol, preferably from about 500 to about 8,000 g/mol and most preferably from about 750 to about 5,000 g/mol.

### BRIEF DESCRIPTION OF THE FIGURES

FIG. 1 provides the GPC trace of molecular weight vs. branching index, g′ᵥᵢₛ, for the product produced in Example #3, showing a branched aPP oligomer.

FIG. 2 provides the GPC trace of molecular weight vs. branching index, g′ᵥᵢₛ, for the product produced in Example #9 (comparative), showing a linear aPP oligomer.

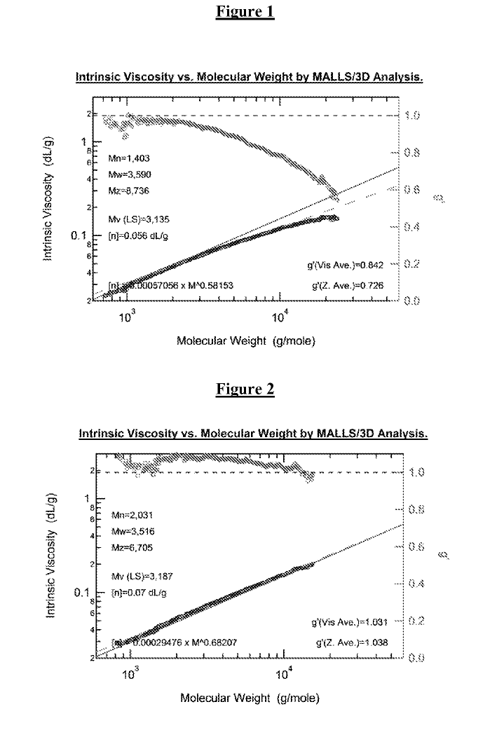

### DETAILED DESCRIPTION

This invention relates to the branched amorphous propylene oligomers and polymers, comprising propylene and less than 5 mol % of comonomer(s), wherein the branched oligomer/polymer:

i) has a g′ᵥᵢₛ of less than 0.98;

ii) has a number average molecular weight (Mₙ) of about 200 (preferably 500) to about 10,000 g/mol, as measured by ¹H NMR;

iii) has a heat of fusion (ΔH_{f}) of less than 10 J/g; and

iv) has greater than 50% allylic chain end functionality.

Described herein are such processes to produce the branched amorphous propylene oligomers, and compositions comprising such branched amorphous propylene oligomers. “Branched” as used herein means a polyolefin having a g′ᵥᵢₛ of 0.98 or less, or if the polyolefin has a Mn (¹H NMR) of less than 7,500 g/mol, the branched polyolefin has a ratio of saturated chain ends to percentage of unsaturated chain ends of greater than 1. These branched polyolefins having high amounts of allyl chain ends may find utility as macromonomers for the synthesis of polyolefin such as linear low density polyethylene, block copolymers, and as additives, for example, as additives to, or blending agents in, lubricants, waxes, and adhesives. Advantageously, when used as an additive, such as to film compositions, the branched nature of these polyolefins may improve rheological properties in molten state and the desired mechanical properties by allowing optimal thermoforming and molding at lower temperatures, thereby reducing energy consumption of the film forming process, as compared to linear polyolefin analogues. Further advantageously, the high amounts of allyl chain ends of these branched polyolefins provides a facile path to functionalization. The functionalized branched polyolefins may be also useful as additives or blending agents.

For the purposes of this invention and the claims thereto, the new numbering scheme for the Periodic Table Groups is used as set out in CHEMICAL AND ENGINEERING NEWS, 63(5), p. 27 (1985). Therefore, a “Group 4 metal” is an element from Group 4 of the Periodic Table.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, including, but not limited to, ethylene, propylene, and butene, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like. Thus, as used herein, the terms “polypropylene,” “propylene polymer,” “propylene copolymer,” and “propylene based polymer” mean a polymer or copolymer comprising at least 50 mol % propylene units (preferably at least 70 mol % propylene units, more preferably at least 80 mol % propylene units, more preferably at least 90 mol % propylene or 100 mol % propylene units (in the case of a homopolymer)). An oligomer is a polymer having a low molecular weight. For purposes of this invention, the term “oligomer” is defined to be a polymer having an Mn of from 100 to 1200 g/mol as measured by ¹H NMR. As above for the term “polymer” when an oligomer is referred to as comprising an olefin, the olefin present in the oligomer is the oligomerized form of the olefin. A co-oligomer is an oligomer comprising at least two different monomer units (such as propylene and ethylene). A homo-oligomer is an oligomer comprising units of the same monomer (such as propylene). A propylene oligomer is an oligomer having at least 50 mol % units derived from propylene, (preferably at least 70 mol % propylene units, more preferably at least 80 mol % propylene units, more preferably at least 90 mol % propylene or 100 mol % propylene units (in the case of a homo-oligomer)).

Branched vinyl terminated oligomer or polymer chains have saturated chain end(s) and an unsaturated chain end. The term “vinyl termination”, also referred to as allyl chain end(s)” or “vinyl chain” is defined to be an oligomer or polymer having at least one terminus represented by CH₂CH—CH₂—, as shown in formula A:

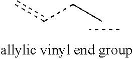

where the “••••” represents the rest of an oligomer or polymer chain. In a preferred embodiment the allyl chain end is represented by the formula B:

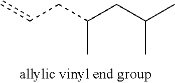

The amount of allyl chain ends (also called % vinyl termination) is determined using ¹H NMR at 120° C. using deuterated tetrachloroethane as the solvent on a 500 MHz machine and in selected cases confirmed by ¹³C NMR. Resconi has reported proton and carbon assignments (neat perdeuterated tetrachloroethane used for proton spectra while a 50:50 mixture of normal and perdeuterated tetrachloroethane was used for carbon spectra; all spectra were recorded at 100° C. on a Bruker AM 300 spectrometer operating at 300 MHz for proton and 75.43 MHz for carbon) for vinyl terminated propylene oligomers in J American Chemical Society, 114, 1992, pp. 1025-1032 that are useful herein.

The percent of allyl chain ends is reported as the molar percentage of allylic vinyl groups relative to total moles of unsaturated chain ends.

The branched oligomers or polymers also have at least one saturated chain end which may comprise an isobutyl chain end. “Isobutyl chain end” is defined to be a chain end or terminus of oligomer or polymer represented by the formula:

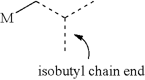

where M represents the rest of an oligomer chain.

The structure of the polymer near the saturated chain end may differ, depending on the types and amounts of monomer(s) used, and mechanisms of monomer insertion during the polymerization process. In some preferred embodiments, where the branched polyolefins comprise propylene-derived units and C₄ to C₄₀ alpha olefin derived units, the structure of the polymer within four carbons of the isobutyl chain end is represented by one of the following formulae:

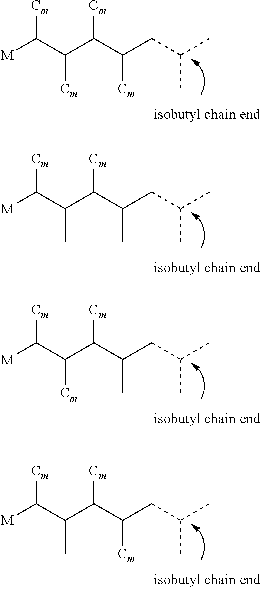

where M represents the rest of the oligomer chain and Cₘ represents the polymerized monomer, each Cₘ may be the same or different, and where m is an integer from 2 to 8.

The percentage of isobutyl end groups is determined using ¹³C NMR (as described in the Example section below) and the chemical shift assignments in Resconi et al, J Am. Chem. Soc. 1992, 114, pp. 1025-1032 for 100% propylene oligomers.

The ratio of isobutyl chain ends to allylic vinyl chain ends is defined to be the ratio of the percentage of isobutyl chain ends to the percentage of allylic vinyl chain ends. For linear oligomer or polymer, the isobutyl chain end to allyl chain end ratio is a representation of the number of vinyl groups present per polymer chain. For example, an isobutyl chain end to allylic vinyl group ratio of about 1:1 indicates that there is, on average, about one allylic vinyl group present per polymer chain. The ratio of isobutyl chain ends to all unsaturated chain ends is an indication of level branching for branched polymers. An isobutyl chain end to unsaturated chain end ratio of greater than 1 implies the presence of branched polymers.

Conversion is the amount of monomer and comonomers (if present) that are converted to polymer products, and is reported as weight percent and is calculated based on the polymer yield and the amount of monomer fed into the reactor.

Catalyst activity (also referred to as catalyst productivity) is a measure of amount of polymer product produced by unit weight of the catalyst in a given time period. For a continuous process, the catalyst activity is reported as the kilogram of polymer product (P) produced per kilogram of catalyst (cat) used (kgP/kgcat). In a batch process, catalyst activity is reported as the grams of polymer product produced per gram of catalyst and per hour (g P/g cat Hr).

### Branched Amorphous Oligomers and Polymers

As used herein the term “branched oligomer or branched polymer” is defined as the polymer molecular architecture obtained when an oligomer (or a polymer) chain (also referred to as macromonomer) with reactive polymerizable chain ends is incorporated into another oligomer/polymer chain during the polymerization of the latter to form a structure comprising a backbone defined by one of the oligomer chains with branches of the other oligomer chains extending from the backbone. Linear oligomer differs structurally from the branched oligomer because of lack of the extended side arms. For some catalyst systems, the oligomer with reactive polymerizable chain end can be generated in-situ and incorporated into another growing chain to form a homogeneous branched oligomer in a single reactor.

Short chain branches are formed through incorporation of comonomer such as 1-butene, 1-hexene and 1-octene. Short-chain branched oligomers or polymers are referred as to linear polymers. A linear polymer has a branching index (g′ᵥᵢₛ) of 0.98 or more, preferably 0.99 or more, preferably 1.0 (1.0 being the theoretical limit of g′ᵥᵢₛ).

Embodiments herein relate to branched amorphous polypropylene having allyl chain ends of 50% or more. The inventors have surprisingly found that the processes disclosed herein give rise to an increased population of branched products, possibly through vinyl macromonomer re-incorporation. Without wishing to be bound by theory, the inventors opine that the branching is likely of the “Y” and/or comb variety, and these branched polyolefins retain high amounts of allyl chain ends.

The branched propylene oligomers and polymers having 50% or more allyl chain ends produced by the processes disclosed herein:

(a) are branched, having at least one of:
(i) a branching index (g′ᵥᵢₛ) of less than 0.98 (preferably 0.95 or less, preferably 0.90 or less, preferably 0.85 or less);
(ii) a ratio of percentage of saturated chain ends (preferably isobutyl chain ends) to percentage of allyl chain ends of 1.1 or greater (preferably 1.2 or greater, preferably 1.4 or greater), wherein the percentage of saturated chain ends is determined using ¹³C NMR as described in Example section below;
(iii) a ratio of Mn(GPC)/Mn(¹H NMR) of 0.95 or less (preferably 0.90 or less, preferably 0.85 or less, preferably 0.80 or less); and/or
(iv) a heat of fusion of 10 J/g or less (preferably 5 J/g or less, preferably 0 J/g or less);

and

(b) have at least 50% allyl chain ends, relative to total unsaturated chain ends (preferably 60% or more, preferably 70% or more, preferably 75% or more, preferably 80% or more, preferably 90% or more, preferably 95% or more) and having at least one of:
(i) a bromine number which, upon complete hydrogenation, decreases by at least 50% (preferably at least 75%);
(ii) an allyl chain end to internal vinylidene ratio of greater than 5:1 (preferably greater than 10:1);
(iii) an allyl chain end to vinylidene chain end ratio of greater than 10:1 (preferably greater than 15:1); and/or
(iv) an allyl chain end to vinylene chain end ratio of greater than 1:1 (preferably greater than 2:1, greater than 5:1, or greater than 10:1).

With respect to branching, in embodiments where the branched oligomers have an Mn (measured by ¹H NMR) of 400 to 20,000 g/mol, the branched polyolefin has:
(i) a branching index (g′ᵥᵢₛ) of less than 0.98 (preferably less than 0.95, less than 0.90, or less than 0.85); and/or
(ii) a ratio of percentage of saturated chain ends (preferably isobutyl chain ends) to percentage of allyl chain ends of 1.1 or greater (preferably 1.2 or greater), wherein the percentage of saturated chain ends is determined using ¹³C NMR; and/or
(iii) a ratio of Mn(GPC)/Mn(¹H NMR) of 0.95 or less (preferably 0.90 or less, preferably 0.85 or less, preferably 0.80 or less). In the event of conflict, g′ᵥᵢₛ shall be used (if g′ᵥᵢₛ cannot be determined, then the ratio of percentage of saturated chain ends to percentage of allyl chain ends shall be used; if the ratio of percentage of saturated chain ends to percentage of allyl chain ends cannot be determined, then the ratio of Mn(GPC)/Mn(¹H NMR) shall be used).

In embodiments where the branched oligomer or polymer have an Mn(GPC) (measured by GPC) of greater than 400 g/mol, the branched oligomer has a g′ᵥᵢₛ of less than 0.95 (preferably 0.90 or less, preferably 0.85 or less) and, optionally, a bromine number which, upon complete hydrogenation, decreases by at least 50% (preferably by at least 75%).

In embodiments where the branched propylene oligomers or polymers have an Mn (measured by ¹H NMR) of greater than 200 g/mol (preferably from 400 to 7,500 g/mol), comprise one or more olefin comonomers (preferably ethylene or a C₄ to C₄₀ alpha olefin, preferably a C₄ to C₂₀ alpha olefin, preferably a C₄ to C₁₂ alpha olefin, preferably butene, pentene, hexene, heptene, octene, nonene, decene, cyclopentene, cycloheptene, cyclooctene, cyclooctadiene, or isomers thereof), and have:
(i) a ratio of percentage of saturated chain ends (preferably isobutyl chain ends) to percentage of allyl chain ends of 1.2 or greater (preferably 1.4 or greater), wherein the percentage of saturated chain ends is determined using ¹³C NMR;
(ii) a ratio of Mn(GPC)/Mn(¹H NMR) of 0.95 or less (preferably 0.90 or less, preferably 0.85 or less, preferably 0.80 or less).

In an alternate embodiment, the branched oligomer and polymers having an Mn (measured by ¹H NMR) of less than 7,500 g/mol (preferably from 100 to 7,500 g/mol) has a g′ᵥᵢₛ of 0.90 or less (preferably 0.85 or less, preferably 0.80 or less).

In one embodiment, the branched oligomers and polymers produced herein have an Mn (measured by ¹H NMR) of 7,500 to 60,000 g/mol, comprise propylene and one or more alpha olefin comonomers (preferably ethylene or a C₄ to C₄₀ alpha olefin, preferably a C₄ to C₂₀ alpha olefin, preferably a C₄ to C₁₂ alpha olefin, preferably butene, pentene, hexene, heptene, octene, nonene, decene, cyclopentene, cycloheptene, cyclooctene, cyclooctadiene, and isomers thereof), and have:
(i) 50% or greater allyl chain ends, relative to total unsaturated chain ends (preferably 60% or more, preferably 70% or more, preferably 75% or more, preferably 80% or more, preferably 90% or more, preferably 95% or more);
(ii) a g′ᵥᵢₛ of 0.95 or less (preferably 0.90 or less, preferably 0.85 or less), and/or a ratio of percentage of saturated chain ends (preferably isobutyl chain ends) to percentage of allyl chain ends of 1.2 or greater (preferably 1.4 or more), and/or a ratio of Mn(GPC)/Mn(¹H NMR) of 0.95 or less (preferably 0.90 or less, preferably 0.85 or less, preferably 0.80 or less);
(iii) a heat of fusion (ΔHf) of less than 10 J/g (preferably less than 5 J/g);
(iv) optionally, an allyl chain end to internal vinylidene ratio of greater than 5:1 (preferably greater than 10:1);
(v) optionally, an allyl chain end to vinylidene chain end ratio of greater than 10:1 (preferably greater than 15:1); and
(vi) optionally, an allyl chain end to vinylene chain end ratio of greater than 1:1 (preferably greater than 2:1, greater than 5:1, or greater than 10:1).

In some embodiments, the branched polyolefins have a branching index, g′ᵥᵢₛ (as determined by GPC), of 0.90 or less (preferably 0.85 or less, preferably 0.80 or less). In other embodiments, the branched polymers have a ratio of saturated chain ends to unsaturated chain ends of greater than 1 (preferably greater than 1.2).

The preferred branched oligomers or polymers described herein have an Mn (measured by ¹H NMR) of 200 to 7,500 g/mol or alternately greater than 400 g/mol. Further, a desirable molecular weight range can be any combination of any upper molecular weight limit with any lower molecular weight limit described above. Mn (¹H NMR) is determined according to the ¹H NMR method described below in the Example section below. Mn may also be determined using a GPC-DRI method, as described below. For the purpose of the claims, unless indicated otherwise, Mn is determined by ¹H NMR.

In another embodiment, the branched oligomers or polymers described herein have an Mw (measured using a GPC-DRI method, as described below) of 400 g/mol or more (preferably from about 400 to about 30,000 g/mol, preferably from about 600 to 20,000 g/mol, preferably from about 1,000 to 20,000 g/mol) and/or an Mz in the range of from about 600 to about 100,000 g/mol or preferably from about 800 to 60,000 g/mol.

In another embodiment, the branched oligomer and polymer have an Mw/Mn in the range of from about 2 to 20 (alternately from about 2.2 to 10, alternately from about 2 to 5.5). Preferably, the Mw/Mn is less than 4.0, more preferably less than 3.0, even more preferably less than 2.5. Both Mn and Mw are determined using GPC-DRI.

In some embodiments, the branched oligomer and polymer have 50% or greater allyl chain ends (preferably 60% or more, preferably 70% or more, preferably 80% or more, preferably 90% or more, preferably 95% or more). Branched oligomer and polymer generally have a chain end (or terminus) which is saturated and/or an unsaturated chain end. The unsaturated chain end of the inventive polymers comprises “allyl chain ends.” An allyl chain end is represented by the formula:

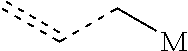

where M represents the rest of polymer chain. “Allylic vinyl group,” “allyl chain end,” “vinyl chain end,” “vinyl termination,” “allylic vinyl group” and “vinyl terminated” are used interchangeably in the following description.

The “allyl chain end to vinylidene chain end ratio” is defined to be the ratio of the percentage of allyl chain ends to the percentage of vinylidene chain ends. In some embodiments, the allyl chain end to vinylidene chain end ratio is more than 10:1 (preferably greater than 15:1).

The “allyl chain end to vinylene chain end ratio” is defined to be the ratio of the percentage of allyl chain ends to the percentage of vinylene chain ends. In some embodiments, the allyl chain end to vinylene chain end ratio is greater than 1:1 (preferably greater than 2:1, greater than 5:1, or greater than 10:1).

The “allyl chain end to internal vinylidene ratio” is defined to be the ratio of the percentage of allyl chain ends to the percentage of internal (or non-terminal) vinylidene groups. In some embodiments, the allyl chain end to internal vinylidene ratio is greater than 5:1 (preferably greater than 10:1).

The unsaturated chain ends may be further characterized by using bromine electrometric titration, as described in ASTM D 1159. The bromine number obtained is useful as a measure of the unsaturation present in the sample. In embodiments herein, branched polyolefins have a bromine number which, upon complete hydrogenation, decreases by at least 50% (preferably by at least 75%).

The branched oligomer and polymer have more than one saturated chain end, preferably at least two saturated chain ends, per branched polyolefin molecule. In some embodiments, the branched oligomer and polymer produced herein have a ratio of percentage of saturated chain ends (preferably isobutyl chain ends) to percentage of all unsaturated chain ends of 1.2 or greater (preferably 1.6 or greater), wherein the percentage of saturated chain ends is determined using ¹³C NMR. Where the branched polyolefins comprise propylene-derived units, the saturated chain end may comprise an isobutyl chain end.

The branched propylene oligomers and polymers are thought to be created through reinsertion of reactive polymerizable oligomers into another growing oligomer chain during polymerization reaction of the latter. The polymerizable oligomer forms the side arms extended from the growing chain (i.e. backbone) and form the branched structures. The branched oligomer has the “Y” (or three-arm star) type branching structure when only one polymerizable oligomer is reinserted into the growing oligomer chain. Likewise, the branched oligomer has a comb type branching structure when more than one polymerizable oligomer is reinserted into the growing oligomer chain. A hypo-branched structure is formed when a branched oligomer with polymerizable chain ends is reinserted into a growing oligomer chain. For propylene oligomer or polymers, the branching point takes place at a single methine carbon where the side arms and the backbone meet. The peaks corresponding to methylenes adjacent to these branch points are found between 44 and 45 ppm for isotactic polypropylene in ¹³C NMR. Assignments for long chain branches of isotactic polypropylene chains using ¹³C NMR are discussed by Weng, Hu, Dekmezian, and Ruff (Macromolecules 2002, 35, pp. 3838-3843). For propylene branches between propylenes in the backbone the methylenes are found at 44.88, 44.74, and 44.08 ppm. The methine of the branch is found at 31.84 ppm. However, in propylene oligomers with a low degree of stereoregularity, the methylenes adjacent to the branch points are found not as discrete signals but as a broad envelope of unresolved resonances between 44.0 and 45.4 ppm. Likewise, the signal of the methine carbon of the branch in propylene oligomers that exhibit a low level of stereoregularity are detected as unresolved resonances between 31.2 and 31.84 ppm. Quantitation of the amount of branching in the oligomers were calculated according to the methodology in Randall, James C. (1989) “A Review Of High Resolution Liquid 13Carbon Nuclear Magnetic Resonance Characterizations Of Ethylene-Based Polymers” Polymer Reviews, 29:2, pp. 201-317.

In other embodiments, the branched oligomers/polymers described herein have a glass transition temperature (Tg) of less than 5° C. or less (as determined by differential scanning calorimetry as described below), preferably 0° C. or less, more preferably −10° C. or less, more preferably −20° C. or less. The glass transition temperature is determined according to ASTM D3418-03.

In another embodiment, any of the branched polyolefins described herein have a viscosity at 60° C. of greater than 50 mPa·sec, greater than 100 mPa·sec, or greater than 500 mPa·sec. In other embodiments, the branched polyolefins have a viscosity at 60° C. of less than 15,000 mPa·sec, or less than 10,000 mPa·sec.

In a preferred embodiment, any of the branched polyolefins described herein comprises less than 3 wt % of functional groups selected from hydroxide, aryls and substituted aryls, halogens, alkoxys, carboxylates, esters, acrylates, oxygen, nitrogen, and carboxyl (preferably less than 2 wt %, less than 1 wt %, less than 0.5 wt %, less than 0.1 wt %, or 0 wt %), based upon the weight of the copolymer.

In another embodiment, any of the branched polyolefins described herein comprises at least 50 wt % (preferably at least 75 wt %, preferably at least 90 wt %), based upon the weight of the copolymer composition, of olefins having at least 36 carbon atoms (preferably at least 51 carbon atoms or at least 102 carbon atoms) as measured by ¹H NMR, assuming one unsaturation per chain.

In another embodiment, the branched oligomers and polymers comprise less than 15 wt % dimer and trimer (preferably less than 10 wt %, preferably less than 5 wt %, more preferably less than 2 wt %, based upon the weight of the copolymer composition), as measured by gas chromatography. “Dimer” (and “trimer”) are defined as copolymers having two (or three) monomer units, where the monomer units may be the same or different from each other (where “different” means differing by at least one carbon). Products are analyzed by gas chromatograph (Agilent 6890N with auto-injector) using helium as a carrier gas at 38 cm/sec. A column having a length of 60 m (J & W Scientific DB-1, 60 m×0.25 mm I.D.×1.0 μm film thickness) packed with a flame ionization detector (FID), an injector temperature of 250° C., and a detector temperature of 250° C. are used. The sample is injected into the column in an oven at 70° C., then heated to 275° C. over 22 minutes (ramp rate 10° C./min to 100° C., 30° C./min to 275° C., hold). An internal standard, usually the monomer, is used to derive the amount of dimer or trimer product that is obtained. Yields of dimer and trimer product are calculated from the data recorded on the spectrometer. The amount of dimer or trimer product is calculated from the area under the relevant peak on the GC trace, relative to the internal standard.

In another embodiment, any of the branched polyolefins described herein contain less than 25 ppm hafnium or zirconium, preferably less than 10 ppm hafnium or zirconium, preferably less than 5 ppm hafnium or zirconium, based on the yield of polymer produced and the mass of catalyst employed. ICPES (Inductively Coupled Plasma Emission Spectrometry), which is described in J. W. Olesik, “Inductively Coupled Plasma-Optical Emission Spectroscopy,” in the Encyclopedia of Materials Characterization, C. R. Brundle, C. A. Evans, Jr. and S. Wilson, eds., Butterworth-Heinemann, Boston, Mass., 1992, pp. 633-644, is used to determine the amount of an element in a material.

In yet other embodiments, the branched polyolefin is a liquid at 25° C.

The branched propylene oligomers/polymers are soluble to aliphatic and aromatic solvents at ambient temperature.

In another embodiment, the branched propylene oligomer/polymer is amorphous and is essentially free of crystallinity. In another embodiment, the branched propylene oligomer/polymer is a propylene homopolymer and the propylene homopolymer is amorphous. In another embodiment, the branched propylene oligomer is a propylene copolymer or propylene co-polymer that is amorphous. Amorphous is defined to mean a heat of fusion of less than 10 J/g, preferably less than 5 Jig. In most cases, the inventive branched propylene oligomer/polymer has a heat of fusion of 0 J/g or less.

In another embodiment, the branched propylene oligomer or polymer is amorphous, and has no detectable melting peak in the heating cycle or crystallization peak in the cooling cycle from DSC. The DSC test is conducted according to ASTM D3418-03.

The branched propylene oligomer and polymers are atactic. It was surprisingly found that some of the stereospecific catalyst systems produce branched atactic vinyl terminated propylene polymers. Olefin polymers and oligomers, in particular poly-alpha-olefin polymers comprising propylene or other C3 or higher alpha-olefin monomers, comprise hydrocarbyl groups that are pendant from the polymer backbone chain. The pendant hydrocarbyl groups may be arranged in different stereochemical configurations determined relative to the polymer backbone chain. Tacticity of a polymer reflects the stereochemical regularity of hydrocarbyl groups which are pendent to the polymer molecule backbone.

Polypropylene microstructure is determined by ¹³CNMR spectroscopy, including the concentration of isotactic and syndiotactic diads ([m] and [r]), triads ([mm] and [rr]), and pentads ([mmmm] and [rrrr]). The designation “m” or “r” describes the stereochemistry of pairs of contiguous propylene groups, “m” referring to meso and “r” to racemic. Samples are dissolved in d2-1,1,2,2-tetrachloroethane, and spectra recorded at 125° C. using a 100 MHz (or higher) NMR spectrometer. Polymer resonance peaks are referenced to mmmm=21.8 ppm. Calculations involved in the characterization of polymers by NMR are described by F. A. Bovey in “Polymer Conformation And Configuration”, (Academic Press, New York 1969) and J. Randall in “Polymer Sequence Determination, ¹³C-NMR Method”, (Academic Press, New York, 1977).

The “propylene tacticity index”, expressed herein as [m/r], is calculated as defined in H. N. Cheng, Macromolecules, 17, p. 1950 (1984). When [m/r] is 0 to less than 1.0, the polymer is generally described as syndiotactic, when [m/r] is 1.0 the polymer is atactic, and when [m/r] is greater than 1.0 the polymer is generally described as isotactic. In a preferred embodiment, the polymers produced herein are atactic and have an [m/r] of about 1.0.

The “mm triad tacticity index” of a polymer is a measure of the relative isotacticity of a sequence of three adjacent propylene units connected in a head-to-tail configuration. More specifically, in the present invention, the mm triad tacticity index (also referred to as the “mm Fraction”) of a polypropylene homopolymer or copolymer is expressed as the ratio of the number of units of meso tacticity to all of the propylene triads in the copolymer:

$$mm Fraction = \frac{PPP ( mm )}{PPP ( mm ) + PPP ( mr ) + PPP ( rrr )}$$

where PPP(mm), PPP(mr) and PPP(rr) denote peak areas derived from the methyl groups of the second units in the possible triad configurations for three head-to-tail propylene units, shown below in Fischer projection diagrams:

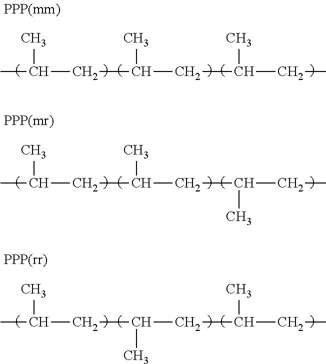

The calculation of the mm Fraction of a propylene polymer is described in U.S. Pat. No. 5,504,172 (homopolymer: column 25, line 49 to column 27, line 26; copolymer: column 28, line 38 to column 29, line 67). For further information on how the mm triad tacticity can be determined from a 13C-NMR spectrum, see 1) J. A. Ewen, “Catalytic Polymerization Of Olefins: Proceedings Of The International Symposium On Future Aspects Of Olefin Polymerization”, T. Keii and K. Soga, Eds. (Elsevier, 1986), pp. 271-292; and 2) U.S. Patent Application Publication No. US 2004/054086 (paragraphs [0043] to [0054]). The branched propylene oligomers and polymers produced herein are atactic. In atactic polymers the substituents are placed randomly along the chain. The percentage of meso diads is between 20 and 80%, preferably between 25 to 75% as determined by ¹³CNMR.

In some embodiments, the branched polyolefin is a homopolymer of propylene. The branched polyolefin may also be a copolymer, a terpolymer, or so on. In some embodiments herein, the branched polyolefin comprises from about 95 to 99.9 mol % (preferably from about 95 to about 98 mol %) of propylene. The arms extended from a backbone of a branched polyolefin comprise a methyl group.

In some embodiments, the branched polyolefin comprises C₄ to C₄₀ monomers, preferably C₄ to C₂₀ monomers, or preferably C₄ to C₁₂ monomers. The C₄ to C₄₀ monomers, may be linear or cyclic. The cyclic olefins may be strained or unstrained, monocyclic or polycyclic, and may optionally include hetero atoms and/or one or more functional groups. Exemplary monomers include butene, pentene, hexene, heptene, octene, nonene, decene, undecene, dodecene, norbornene, cyclopentene, cycloheptene, cyclooctene, cyclododecene, 7-oxanorbornene, substituted derivatives thereof, and isomers thereof, preferably hexane, heptene, octene, nonene, decene, dodecene, cyclooctene, 1-hydroxy-4-cyclooctene, 1-acetoxy-4-cyclooctene, cyclopentene, norbornene, and their respective homologs and derivatives.

In some embodiments, the branched polyolefin comprises two or more different C₄ to C₄₀ monomers, three or more different C₄ to C₄₀ monomers, or four or more different C₄ to C₄₀ monomers. In some embodiments herein, the branched polyolefin comprises from about 0.1 to 5 mol % of at least one (preferably two or more, three or more, four or more, and the like) C₄ to C₄₀ (preferably butene, pentene, hexene, heptene, octene, nonene, decene, cyclopentene, cycloheptene, cyclooctene, cyclooctadiene, and isomers thereof) monomers.

In some embodiments, the branched polyolefins are homopolypropylene, propylene/ethylene copolymers, propylene/butane copolymer, propylene/hexene copolymers, propylene/octene copolymers, propylene/decene copolymers, propylene/hexene/octene terpolymers, propylene/hexene/decene terpolymers, propylene/octene/decene terpolymers, and the like.

In another embodiment, the branched polyolefins produced herein have an Mn (measured by ¹H NMR) of less than 7,500 g/mol (preferably from 100 to 7,500 g/mol), comprise propylene and one or more alpha olefins (preferably ethylene and/or a C₄ to C₄₀ alpha olefin (preferably a C₄ to C₂₀ alpha olefin, preferably a C₄ to C₁₂ alpha olefin, preferably butene, pentene, hexene, heptene, octene, nonene, decene, cyclopentene, cycloheptene, cyclooctene, cyclooctadiene, and isomers thereof) and have:
(i) 50% or greater allyl chain ends, relative to total number of unsaturated chain ends (preferably 60% or more, preferably 70% or more, preferably 75% or more, preferably 80% or more, preferably 90% or more, preferably 95% or more);
(ii) a ratio of percentage of saturated chain ends (preferably isobutyl chain ends) to percentage of allyl chain ends of 1.2 or greater (preferably 1.6 or greater), wherein the percentage of saturated chain ends is determined using ¹³C NMR, and/or a ratio of Mn(GPC)/Mn(¹H NMR) of 0.95 or less (preferably 0.90 or less, preferably 0.85 or less, preferably 0.80 or less);
(iii) a heat of fusion of less than 10, preferably less than 5 J/g.;
(v) optionally, an allyl chain end to internal vinylidene ratio of greater than 5:1 (preferably greater than 10:1);
(vi) optionally, an allyl chain end to vinylidene chain end ratio of greater than 10:1 (preferably greater than 15:1); and
(vii) optionally, an allyl chain end to vinylene chain end ratio of greater than 1:1 (preferably greater than 2:1, greater than 5:1, or greater than 10:1).

Useful branched oligomers and polymers produced herein also include propylene polymers comprising: (i) at least 95 mol % propylene; (ii) from 0.1 to 5 mol % ethylene; and (iii) from 0.1 to 5 (preferably 0.5 to 3, preferably 0.5 to 1) mol % diene (such as C₄ to C₁₂ alpha-omega dienes (such as butadiene, hexadiene, octadiene), norbornene, ethylidene norbornene, vinylnorbornene, norbornadiene, and dicyclopentadiene), wherein the branched polymer has: (a) at least 90% allyl chain ends (preferably at least 91%, preferably at least 93%, preferably at least 95%, preferably at least 98%); (b) an Mn (measured by ¹H NMR) of 100 g/mol or greater (preferably in the range of from about 150 to about 60,000 g/mol, preferably 200 to 45,000 g/mol, preferably 250 to 25,000 g/mol, preferably 300 to 10,000 g/mol, preferably 400 to 9,500 g/mol, preferably 500 to 9,000 g/mol, preferably 750 to 9,000 g/mol); and (c) an isobutyl chain end to allylic vinyl group ratio of 1.2 or greater.

Useful branched polymers that may be produced as described herein include polymers having an Mn (measured by ¹H NMR) of 200 g/mol or more, (preferably 300 to 60,000 g/mol, 400 to 50,000 g/mol, preferably 500 to 35,000 g/mol, preferably 300 to 15,000 g/mol, preferably 400 to 12,000 g/mol, or preferably 750 to 10,000 g/mol); and comprising: (i) about 0.1 to 5 mol % of at least one C₅ to C₄₀ olefin (preferably C₅ to C₃₀ α-olefins, more preferably C₅ to C₂₀ α-olefins, preferably, C₅ to C₁₂ α-olefins, preferably pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene); and (ii) from about 95 to 99 mol % of propylene; wherein the branched polymer has at least 40% allyl chain ends (preferably at least 50%, at least 60%, at least 70%; at least 80%, at least 90%; at least 95%); and, optionally, an isobutyl chain end to allylic chain end ratio of less than 0.70:1 (preferably less than 0.65:1, less than 0.60:1, less than 0.50:1, or less than 0.25:1); and, further, optionally, an allyl chain end to vinylidene chain end (as determined by ¹H NMR) ratio of more than 2:1 (preferably more than 2.5:1, more than 3:1, more than 5:1, or more than 10:1); and, further, optionally, an allyl chain end to vinylene chain end ratio of greater than 10:1 (preferably greater than 15:1, or greater than 20:1); and, even further, optionally, preferably substantially no isobutyl chain ends (preferably less than 0.1 wt % isobutyl chain ends).

Useful branched vinyl terminated polymers produced herein further include propylene polymers comprising more than 95 mol % and less than 5 mol % ethylene (preferably 1 to 4 mol % or preferably 1 to 2 mol %), wherein the polymer has: (i) at least 93% allyl chain ends (preferably at least 95%, preferably at least 97%, preferably at least 98%); (ii) an Mn (measured by ¹H NMR) of 100 g/mol or greater (preferably in the range of from about 150 to about 60,000 g/mol, preferably 200 to 45,000 g/mol, preferably 250 to 25,000 g/mol, preferably 300 to 10,000 g/mol, preferably 400 to 9,500 g/mol, preferably 500 to 9,000 g/mol, or preferably 750 to 9,000 g/mol); and (iii) a ratio of isobutyl chain end to allylic vinyl group ratio of 1.2 or more, and less than 1400 ppm aluminum (preferably less than 1200 ppm, preferably less than 1000 ppm, preferably less than 500 ppm, or preferably less than 100 ppm).

In another embodiment, any of the vinyl terminated polyolefins described or useful herein have 3-alkyl vinyl end groups (where the alkyl is a C₁ to C₃₈ alkyl), also referred to as a “3-alkyl chain ends” or a “3-alkyl vinyl termination”, represented by the formula:

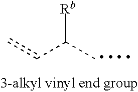

where “••••” represents the rest of a polyolefin chain and Rb is a C₁ to C₃₈ alkyl group, preferably a C₁ to C₂₀ alkyl group, such as methyl, ethyl, propyl, butyl, pentyl, hexyl, heptyl, octyl, nonyl, decyl, undecyl, docecyl, and the like. The amount of 3-alkyl chain ends is determined using ¹³C NMR as set out below.

In a preferred embodiment, any of the vinyl terminated polyolefins described or useful herein have at least 5% 3-alkyl chain ends (preferably at least 10%, at least 20%, at least 30%; at least 40%, at least 50%, at least 60%, at least 70%; at least 80%, at least 90%; at least 95%), relative to total unsaturation.

In a preferred embodiment, any of the vinyl terminated polyolefins described or useful herein have at least 5% of 3-alkyl+allyl chain ends (e.g., all 3-alkyl chain ends plus all allyl chain ends), preferably at least 10%, at least 20%, at least 30%, at least 40%, at least 50%, at least 60%, at least 70%; at least 80%, at least 90%; at least 95%), relative to total unsaturation.

### Processes for Making Branched Amorphous Propylene Oligomers/Polymers

Described herein are processes to produce the branched amorphous propylene oligomers/polymers. The branched propylene oligomers/polymers are thought to be created through reinsertion of reactive polymerizable oligomers/polymers into another growing oligomer/polymer chain during polymerization reaction of the latter. The polymerizable oligomer/polymer forms the side arms extended from the growing chain (i.e. backbone) and form the branched structures. The branched oligomer/polymer has the “Y” (or three-arm star) type branching structure when only one polymerizable oligomer/polymer is reinserted into the growing oligomer/polymer chain. Likewise, the branched oligomer/polymer has a comb type branching structure when more than one polymerizable oligomers/polymers are reinserted into the growing oligomer/polymer chain. A hypo-branched structure is formed when a branched oligomer/polymer with polymerizable chain ends is reinserted into a growing oligomer/polymer chain. Branched oligomer/polymer structure is different from oligomer/polymer with short chain branching formed through incorporation of a comonomer such as 1-butene, 1-hexene, 1-octene or other higher alpha olefin. Polymerizable oligomers/polymers can be produced in-situ and reinserted into another growing oligomer/polymer chain in the same reactor using the same catalyst system. A homogeneous branched oligomer/polymer is formed when the composition of the side arms is the same as that in the backbone. Level of branching can be measured by a branching index, g′ᵥᵢₛ. “Branched” as used herein, means a polyolefin having a g′ᵥᵢₛ of 0.98 or less, or if the polyolefin has a Mn (¹H NMR) of less than 7,500 g/mol, the branched polyolefin has a ratio of saturated chain ends to percentage of unsaturated chain ends of greater than 1.0.

Reactive polymerizable oligomers/polymers are referred as to the oligomers/polymers with at least one unsaturated chain end such as vinyl or vinylidene chain ends. Preferably, the unsaturated chain end is a vinyl chain end. The oligomers/polymers can be incorporated into an oligomer/polymer chain in a polymerization environment.

This invention relates to a process to produce branched amorphous propylene oligomers or polymers, wherein the process comprises contacting propylene and optional ethylene and/or C₄ to C₂₀ alpha olefin in the presence of at least one catalyst capable of producing propylene oligomers/polymers with allyl chain end and reinserting the oligomer/polymer into another oligomer/polymer chain to form branched oligomers/polymers.

This invention relates to a polymerization process to produce branched propylene oligomer/polymer, wherein the formation of oligomer/polymers with allyl chain end and reinsertion of oligomer/polymers with allyl chain ends into another oligomer/polymer take place in the same polymerization zone or in the same reactor. Preferably a single catalyst system is used. The catalyst system is capable of producing oligomer/polymer with allyl chain end and reinserting the oligomer/polymer into another oligomer/polymer to form branched oligomer/polymer. Alternatively at least two catalysts are employed; at least one catalyst is capable of producing oligomer/polymer with allyl chain end and at least one catalyst is capable of incorporating the oligomer/polymer to form branched oligomers/polymers.

In another embodiment, the oligomers/polymers with allyl chain end are produced separately. The pre-made oligomers/polymers are then fed into a reactor along with propylene and optionally ethylene and/or C₄ to C₂₀ alpha olefin as well as other feed stream. Propylene, catalyst and pre-made oligomers/polymers are contacted in the reactor. The premade oligomers/polymers are incorporated into a propylene oligomer or polymer chain to form branched oligomer or polymers.

The inventive branched propylene oligomers/polymers can also be produced in a process with two reactors in series configuration. Part of oligomers/polymers with allyl chain end can be made in the first reactor. At least part of the content from the first reactor can be transferred into the second reactor and part of the oligomers/polymers can be reinserted into an oligomer/polymer chain to form branched oligomers/polymers in the second reactor. In one embodiment, at least one catalyst is fed into the first reactor and no additional catalyst is added into the second reactor. Alternatively, at least one catalyst is fed into the first reactor and at least another catalyst different from the first catalyst is added into the second reactor. In another embodiment, both the two catalysts can be added into the first reactor.

Formation of branched propylene oligomers/polymers is a result of two competitive reaction steps. Oligomer/polymer reinsertion competes with monomer insertion during the oligomerization/polymerization. For most catalyst systems, the insertion rates of oligomer/polymer and monomer increase with their concentration in the reactor. Process conditions in favor of oligomer/polymer reinsertion include high concentration of oligomer/polymer with allyl chain end and low monomer concentration. Preferably the ratio of oligomer/polymer weight concentration to the weight concentration of monomer is 1.2 or more, more preferably 1.5 or more, even more preferably 2.0 or more.

In an alternate embodiment, the conversion of olefin monomer is at least 50 mol %, preferably 60 mol % or more, preferably 70 mol % or more, preferably 80 mol % or more. Monomer conversion is calculated based on the oligomer/polymer yield and monomer feed rate.

In a preferred embodiment, the propylene concentration in the feed is 60 vol % of solvent or less, preferably 40 vol % or less, or preferably 20 vol % or less based on the total volume of the feed stream.

In one embodiment, the polymerization process is carried out in a bulk process. In a bulk process, propylene is used as both the monomer and solvent for the process. No solvent/diluent is fed into the reactor even though a small fraction of solvent can be used as a carrying solvent for the catalyst and scavenger. In the bulk process, the propylene conversion is preferably 50% or greater, preferably 60% or more, even more preferably 70% or more.

This invention also relates to a process for polymerization/oligomerization comprising:
(i) contacting, at a temperature greater than 35° C. (preferably in the range of from about 35 to 150° C., from 40 to 140° C., from 60 to 140° C., or from 80 to 130° C.), propylene and, optionally, one or more ethylene and C₄ to C₄₀ alpha olefin monomers (preferably butene, pentene, hexene, heptene, octene, nonene, decene, cyclopentene, cycloheptene, cyclooctene, cyclooctadiene, and isomers thereof), with a catalyst system capable of producing a branched propylene oligomers/polymers having allyl chain ends, the catalyst system comprising a metallocene catalyst compound and an activator;
(ii) converting at least 40 mol % of the monomer to polyolefin (preferably at least 50 mol %, at least 60 mol %, at least 70 mol %); and
(iii) obtaining a branched propylene oligomer or polymers having greater than 50% allyl chain ends, relative to total unsaturated chain ends (preferably 60% or more, preferably 70% or more, preferably 80% or more, preferably 90% or more, preferably 95% or more) and a heat of fusion of 10 J/g or less (preferably 5 J/g or less).

The inventive processes described herein can be run at temperatures and pressures suitable for commercial production of these branched propylene oligomers or polymers. Typical temperatures and/or pressures include a temperature greater than 35° C. (preferably in the range of from about 35 to 150° C., from 40 to 140° C., from 60 to 140° C., or from 80 to 130° C.) and a pressure in the range of from about 0.1 to 10 MPa (preferably from 0.5 to 6 MPa or from 1 to 4 MPa).

The inventive processes described herein have a residence time suitable for commercial production of these branched propylene oligomers or polymers. In a typical polymerization, the residence time of the polymerization process is up to 300 minutes, preferably in the range of from about 5 to 300 minutes, preferably from 10 to 250 minutes, preferably from about 10 to 120 minutes, or preferably from about 10 to 60 minutes. At a given feed condition, long residence time may increase the monomer conversion, thereby increasing the oligomer/polymer concentration and decreasing the monomer concentration in a reactor. This will enhance the level of branching of the oligomer/polymer. In one embodiment, the residence time is used to control the branching level and to optimize the branching structures for specific end-uses.

Optional comonomers useful herein to make oligomers/polymers having allyl chain ends include ethylene and/or C₄ to C₄₀ olefins, preferably ethylene and/or C₅ to C₂₅ olefins, or preferably ethylene and/or C₆ to C₁₈ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. Exemplary, C₄ to C₄₀ olefin monomers include butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives.

Suitable diluents/solvents for polymerization include non-coordinating and inert liquids. Examples include straight and branched-chain hydrocarbons such as isobutane, butane, pentane, isopentane, hexanes, isohexane, heptane, octane, dodecane, and mixtures thereof; cyclic and alicyclic hydrocarbons such as cyclohexane, cycloheptane, methylcyclohexane, methylcycloheptane, and mixtures thereof, such as can be found commercially (Isopar™); and perhalogenated hydrocarbons such as perfluorinated C₄₋₁₀ alkanes. Suitable solvents also include liquid olefins which may act as monomers or comonomers including propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbons are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof.

The inventive processes described herein are run at commercial rates. In some embodiments, the catalyst productivity is 10,000 kilogram of polymer per kilogram of catalyst, preferable 15 kg polymer/kg catalyst, more preferable 20 kg polymer/kg catalyst, even more preferably 40 kg polymer/kg catalyst.

Processes of this invention can be carried out in any manner known in the art. Any bulk, homogeneous solution, boiling pool or slurry process known in the art can be used. Such processes can be run in a batch, semi-batch, or continuous mode. Homogeneous solution polymerization processes and solution are preferred. A homogeneous polymerization process is defined to be a process where at least 90 wt % of the product is soluble in the reaction media. A bulk homogeneous process is particularly preferred. A bulk polymerization process is carried out by using liquid monomers as a solvent. For the claim herein a bulk process is defined to be a process where monomer concentration in all feeds to the reactor is 70 vol % or more. Alternately, no solvent or diluent is present or added in the reaction medium (except for the small amounts used as the carrier for the catalyst system or other additives, or amounts typically found with the monomer; e.g., propane in propylene). By “continuous mode” is meant that there is continuous addition to, and withdrawal of reactants and products from, the reactor system. Continuous processes can be operated in steady state; i.e., the composition of effluent remains fixed with time if the flow rate, temperature/pressure and feed composition remain invariant. For example, a continuous process to produce a polymer would be one where the reactants are continuously introduced into one or more reactors and polymer product is continuously withdrawn.

A “reaction zone” also referred to as a “polymerization zone” is defined as an area where activated catalysts and monomers are contacted and a polymerization reaction takes place. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization described herein occurs within a single reaction zone. Alternately the polymerization described herein may occur in multiple reaction zones. Various feed configurations can be used depending on such factors as the desired product properties, such as, for example, molecular weight distribution and level of branching. Such feed configurations are well known in the art of chemical engineering and can be readily optimized for the desired production scale and product properties using known engineering techniques.

The invented branched propylene oligomers and polymers can also be produced in a bubble column type of reactor. For purposes herein, a bubble column reactor system refers to a cylindrical vessel with a gas distributor at the bottom. The gas is introduced into the column through the distributor, and dispersed in a liquid in forms of bubbles. The liquid either stays in the column in a batch mode of operation, or is continuously fed into and discharged from the column in a continuous process through associated piping, valves, heat exchangers, and the like. A bubble column reactor system may also be referred to as a slurry column, wherein solid particles are suspended in the bulk liquid phase to form a liquid-solid suspension (or liquid-solid slurry). The difference between a bubble column and a slurry column lie in that slurry column has a liquid-solid phase instead of a liquid phase as the bulk liquid phase of the bubble column. Both bubble column and slurry column have similar characteristics and share the same type of designs and operations. Bubble column reactors have been built in numerous forms of construction. The mixing is done by the gas sparging and it requires less energy than mechanical stirring. The liquid can be in parallel flow or counter-current flow. The features and characteristics of bubble column type of reactors are well documented in the literature (e.g., Bubble Column Reactions, by Wolf-Dieter Deckwer, published by John Wiley & Sons in December 1991) which is incorporated by reference herein in its entirety. For production of branched propylene oligomer or polymer, the propylene can be fed into the reactor in gas phase and present in the reactor in form of bubbles. The branched oligomers or polymers are in a liquid phase. This process allows for low operating pressure as compared with that in a solution process. Preferably, the operating pressure is less than 1 MPa, more preferable less than 0.5 MPa.

The polymer product can be recovered from solution at the completion of the polymerization by any of the techniques well known in the art such as steam stripping followed by extrusion drying or by devolatilizing extrusion. Separated solvent/diluent and monomers can be recycled back in the reactor.

In a preferred embodiment hydrogen is present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa). It has been found that in the present systems, hydrogen can be used to provide increased catalyst activity without significantly impairing the catalyst's ability to produce allylic chain ends. Preferably the catalyst activity is at least 5% higher than the same reaction without hydrogen present, preferably at least 10% higher, preferably at least 15% higher.

In a preferred embodiment, little or no alumoxane is used in the process to produce the vinyl terminated polymers. Preferably, alumoxane is present at zero mol %, alternately the alumoxane is present at a molar ratio of aluminum to transition metal less than 500:1, preferably less than 300:1, preferably less than 100:1, preferably less than 1:1.

In an alternate embodiment, if an alumoxane is used to produce the branched oligomers with vinyl terminated chain end, then the alumoxane has been treated to remove free alkyl aluminum compounds, particularly trimethyl aluminum.

In a preferred embodiment, little or no scavenger is used in the process to produce the vinyl terminated polymers. Preferably, scavenger (such as tri alkyl aluminum) is present at zero mol %, alternately the scavenger is present at a molar ratio of scavenger metal to transition metal of less than 100:1, preferably less than 50:1, preferably less than 15:1, preferably less than 10:1.

In a preferred embodiment, the polymerization: 1) is conducted at temperatures of 0 to 300° C. (preferably 25 to 150° C., preferably 40 to 120° C., preferably 45 to 80° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are present in the solvent at less than 1 wt %, preferably at 0.5 wt %, preferably at 0 wt % based upon the weight of the solvents); 4) wherein the catalyst system used in the polymerization comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1); 5) the polymerization occurs in one reaction zone; 6) the productivity of the catalyst compound is at least 10,000 kg polymer/kg catalyst (preferably at least 15,000 kg polymer/kg catalyst, preferably at least 20,000 kg polymer/kg catalyst, preferably at least 50,000 kg polymer/kg catalyst, preferably at least 100,000 kg polymer/kg catalyst); 7) optionally scavengers (such as trialkyl aluminum compounds) are absent (e.g., present at zero mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound.

### Catalyst Systems

Catalysts useful to this invention include the catalysts capable of producing oligomers/polymers with reactive polymerizable chain ends and capable of incorporating oligomers/polymers with polymerizable chain ends to form branched oligomers or polymers. In a preferred embodiment, the branched oligomers/polymers can be produced using one or more activators in combination with one or more of the metallocene catalyst compounds. Most preferably metallocene catalyst compounds are those bridged (especially silyl- or germanyl-bridged) bis-cyclopentadienyl, bridged bis-indenyl, or bridged bis-tetrahydroindenyl zirconocenes or hafnocenes, most preferably those that are C1 to C6 subsituted in one or two positions on each of the ring systems bound to the transition metal center.

In the description herein, the catalyst may be described as a catalyst precursor, a pre-catalyst compound, a catalyst compound, or a transition metal compound, and these terms are used interchangeably. A polymerization catalyst system is a catalyst system that can polymerize monomers to polymer. A “catalyst system” is a combination of at least one catalyst compound, at least one activator, an optional co-activator, and an optional support material. An “anionic ligand” is a negatively charged ligand which donates one or more pairs of electrons to a metal ion. A “neutral donor ligand” is a neutrally charged ligand which donates one or more pairs of electrons to a metal ion.

For the purposes of this invention and the claims thereto, when catalyst systems are described as comprising neutral stable forms of the components, it is well understood by one of ordinary skill in the art, that the ionic form of the component is the form that reacts with the monomers to produce polymers.

A metallocene catalyst is defined as an organometallic compound with at least one it-bound cyclopentadienyl moiety (or substituted cyclopentadienyl moiety) and more frequently two π-bound cyclopentadienyl-moieties or substituted moieties. This includes other π-bound moieties such as indenyls or fluorenyls or derivatives thereof. The term “substituted” means that a hydrogen group has been replaced with a hydrocarbyl group, a heteroatom, or a heteroatom containing group. For example, methyl cyclopentadiene (Cp) is a Cp group substituted with a methyl group, ethyl alcohol is an ethyl group substituted with an —OH group, and a “substituted hydrocarbyl” is a radical made of carbon and hydrogen where at least one hydrogen is replaced by a heteroatom.

In some embodiments, the metallocene may be represented by Formula I, below.

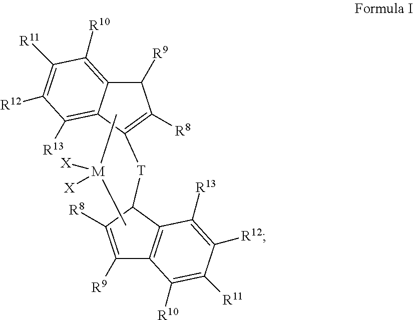

where M is hafnium or zirconium, preferably hafnium;
each X is, independently, selected from the group consisting of a substituted or unsubstituted hydrocarbyl radicals having from 1 to 20 carbon atoms, hydrides, amides, alkoxides, sulfides, phosphides, halides, dienes, amines, phosphines, ethers, and a combination thereof (two X's may form a part of a fused ring or a ring system); preferably each X is independently selected from halides and C₁ to C₆ hydrocarbyl groups, preferably each X is methyl, ethyl, propyl, butyl, phenyl, benzyl, chloride, bromide, or iodide;
each R⁸ is, independently, a substituted or unsubstituted C₁ to C₁₀ alkyl group; preferably methyl, ethyl, propyl, butyl, pentyl, hexyl, heptyl, octyl, nonyl, decyl, or isomers thereof; preferably methyl, n-propyl, or n-butyl; or preferably methyl;
each R⁹ is, independently, a substituted or unsubstituted C₁ to C₁₀ alkyl group; preferably methyl, ethyl, propyl, butyl, pentyl, hexyl, heptyl, octyl, nonyl, decyl, or isomers thereof; preferably methyl, n-propyl, or butyl; or preferably n-propyl;
each R¹⁰ is hydrogen;
each R¹¹, R¹², and R¹³, is, independently, hydrogen or a substituted or unsubstituted hydrocarbyl group, a heteroatom or heteroatom containing group; preferably each R¹¹, R¹², and R¹³, is hydrogen;
T is a bridging group represented by the formula R₂^{a}J where J is C, Si or Ge, preferably Si;
each R^{a} is, independently, hydrogen, halogen or a C₁ to C₂₀ hydrocarbyl, such as methyl, ethyl, propyl, butyl, pentyl, hexyl, heptyl, octyl, phenyl, benzyl, substituted phenyl, and two Ra can form a cyclic structure including aromatic, partially saturated or saturated cyclic or fused ring system;
further provided that any two adjacent R groups may form a fused ring or multicenter fused ring system where the rings may be aromatic, partially saturated or saturated. T may also be a bridging group as defined above for R₂^{a}T; and
further provided that any of adjacent R¹¹, R¹², and R¹³ groups may form a fused ring or multicenter fused ring system where the rings may be aromatic, partially saturated or saturated.

Metallocene compounds that are particularly useful in this invention include one or more of:
rac-dimethylsilyl bis(2-methyl,3-propylindenyl)hafniumdimethyl,
rac-dimethylsilyl bis(2-methyl,3-propylindenyl)zirconiumdimethyl,
rac-dimethylsilyl bis(2-ethyl,3-propylindenyl)hafniumdimethyl,
rac-dimethylsilyl bis(2-ethyl,3-propylindenyl)zirconiumdimethyl,
rac-dimethylsilyl bis(2-methyl,3-ethylindenyl)hafniumdimethyl,
rac-dimethylsilyl bis(2-methyl,3-ethylindenyl)zirconiumdimethyl,
rac-dimethylsilyl bis(2-methyl,3-isopropylindenyl)hafniumdimethyl,
rac-dimethylsilyl bis(2-methyl,3-isopropylindenyl)zirconiumdimethyl,
rac-dimethylsilyl bis(2-methyl,3-butyllindenyl)hafniumdimethyl,
rac-dimethylsilyl bis(2-methyl,3-butylindenyl)zirconiumdimethyl,
rac-dimethylgermanyl bis(2-methyl,3-propylindenyl)hafniumdimethyl,
rac-dimethylgermanyl bis(2-methyl,3-propylindenyl)zirconiumdimethyl,
rac-dimethylgermanyl bis(2-ethyl,3-propylindenyl)hafniumdimethyl,
rac-dimethylgermanyl bis(2-ethyl,3-propylindenyl)zirconiumdimethyl,
rac-dimethylgermanyl bis(2-methyl,3-ethylindenyl)hafniumdimethyl,
rac-dimethylgermanyl bis(2-methyl,3-ethylindenyl)zirconiumdimethyl,
rac-dimethylgermanyl bis(2-methyl,3-isopropylindenyl)hafniumdimethyl,
rac-dimethylgermanyl bis(2-methyl,3-isopropylindenyl)zirconiumdimethyl,
rac-dimethylgermanyl bis(2-methyl,3-butyllindenyl)hafniumdimethyl,
rac-dimethylgermanyl bis(2-methyl,3-propylindenyl)zirconiumdimethyl,
rac-dimethylsilyl bis(2-propyl,3-methylindenyl)hafniumdimethyl,
rac-dimethylsilyl bis(2-propyl,3-methylindenyl)zirconiumdimethyl,
rac-dimethylsilyl bis(2-propyl,3-ethylindenyl)hafniumdimethyl,
rac-dimethylsilyl bis(2-propyl,3-ethylindenyl)zirconiumdimethyl,
rac-dimethylsilylbis(2-propyl,3-butylindenyl)hafniumdimethyl,
rac-dimethylsilylbis(2-propyl,3-butylindenyl)zirconiumdimethyl,
rac-dimethylsilyl bis(2-methyl,3-butylindenyl)hafniumdimethyl,
rac-dimethylsilyl bis(2-methyl,3-butylindenyl)zirconiumdimethyl,
rac-dimethylsilyl bis(2,3-dimethyl)hafniumdimethyl,
rac-dimethylsilyl bis(2,3-dimethyl)zirconiumdimethyl,
rac-dimethylgermanyl bis(2-propyl,3-methylindenyl)hafniumdimethyl,
rac-dimethylgermanyl bis(2-propyl,3-methylindenyl)zirconiumdimethyl,
rac-dimethylgermanyl bis(2-propyl,3-ethylindenyl)hafniumdimethyl,
rac-dimethylgermanyl bis(2-propyl,3-ethylindenyl)zirconiumdimethyl,
rac-dimethylgermanyl bis(2-propyl,3-butylindenyl)hafniumdimethyl,
rac-dimethylgermanyl bis(2-propyl,3-butylindenyl)zirconiumdimethyl,
rac-dimethylgermanyl bis(2-methyl,3-butylindenyl)hafniumdimethyl,
rac-dimethylgermanyl bis(2-methyl,3-butylindenyl)zirconiumdimethyl,
rac-dimethylgermanyl bis(2,3-dimethyl)hafniumdimethyl, and
rac-dimethylgermanyl bis(2,3-dimethyl)zirconiumdimethyl.

In an alternate embodiment, the “dimethyl” after the transition metal in the list of catalyst compounds above is replaced with a dihalide (such as dichloride or difluoride) or a bisphenoxide, particularly for use with an alumoxane activator.

In particular embodiments, the metallocene compound is rac-dimethylsilyl bis(2-methyl,3-propylindenyl)hafniumdimethyl (a), rac-dimethylsilyl bis(2-methyl,3-propylindenyl)zirconiumdimethyl (b), represented by the formulae below:

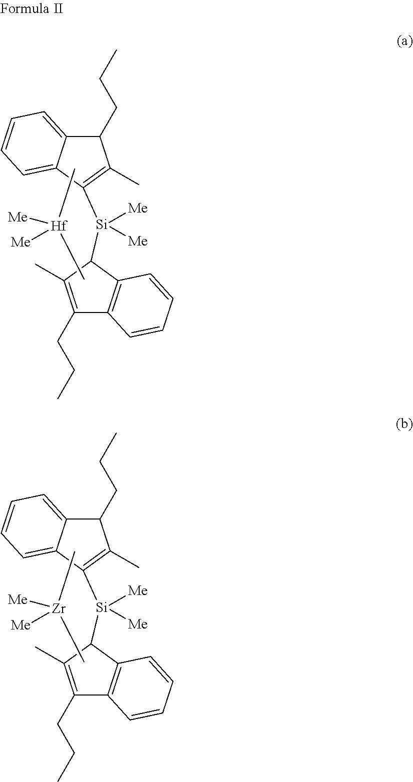

In an alternate embodiment, the “dimethyl” (Me₂) after the transition metal in the list of catalyst compounds above is replaced with a dihalide (such as dichloride or difluoride) or a bisphenoxide, particularly for use with an alumoxane activator.

### Activator Component of Catalyst System

The terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract one reactive, σ-bound, metal ligand making the metal complex cationic and providing a charge-balancing noncoordinating or weakly coordinating anion.

In one embodiment, alumoxane activators are utilized as an activator in the catalyst composition. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. Another alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

When the activator is an alumoxane (modified or unmodified), some embodiments select the maximum amount of activator at a 5000-fold molar excess Al/M over the catalyst precursor (per metal catalytic site). The minimum activator-to-catalyst-precursor is a 1:1 molar ratio. Alternate preferred ranges include up to 500:1, alternately up to 200:1, alternately up to 100:1, or alternately from 1:1 to 50:1.

In an alternate embodiment, little or no alumoxane is used in the process to produce the oligomers/polymers. Preferably, alumoxane is present at zero mol %, alternately the alumoxane is present at a molar ratio of aluminum to transition metal less than 500:1, preferably less than 300:1, preferably less than 100:1, preferably less than 1:1. In an alternate embodiment, if an alumoxane is used to produce the oligomers/polymers then, the alumoxane has been treated to remove free alkyl aluminum compounds, particularly trimethyl aluminum. Further, in a preferred embodiment, the activator used herein to produce the oligomers/polymers is bulky as defined herein and is discrete.

Aluminum alkyl or organoaluminum compounds which may be utilized as co-activators (or scavengers) include trimethylaluminum, triethylaluminum, triisobutylaluminum, tri-n-hexylaluminum, tri-n-octylaluminum, and the like.

### Ionizing Activators

It is within the scope of this invention to use an ionizing or stoichiometric activator, neutral or ionic, such as tri(n-butyl) ammonium tetrakis(pentafluorophenyl)borate, a tris perfluorophenyl boron metalloid precursor or a tris perfluoronaphthyl boron metalloid precursor, polyhalogenated heteroborane anions (PCT Publication No. WO 98/43983), boric acid (U.S. Pat. No. 5,942,459), or combination thereof. It is also within the scope of this invention to use neutral or ionic activators alone or in combination with alumoxane or modified alumoxane activators. Preferred activators are the ionic activators.

Examples of neutral stoichiometric activators include tri-substituted boron, tellurium, aluminum, gallium and indium or mixtures thereof. The three substituent groups are each independently selected from alkyls, alkenyls, halogens, substituted alkyls, aryls, arylhalides, alkoxy, and halides. Preferably, the three groups are independently selected from halogen, mono or multicyclic (including halosubstituted) aryls, alkyls, alkenyl compounds, and mixtures thereof, preferred are alkenyl groups having 1 to 20 carbon atoms, alkyl groups having 1 to 20 carbon atoms, alkoxy groups having 1 to 20 carbon atoms, and aryl groups having 3 to 20 carbon atoms (including substituted aryls). More preferably, the three groups are alkyls having 1 to 4 carbon groups, phenyl, naphthyl or mixtures thereof. Even more preferably, the three groups are halogenated, preferably fluorinated, aryl groups. Most preferably, the neutral stoichiometric activator is tris perfluorophenyl boron or tris perfluoronaphthyl boron.

Ionic catalysts can be preparedly reacting a transition metal compound with some neutral Lewis acids, such as B(C₆F₆)₃, which upon reaction with the hydrolyzable ligand (X) of the transition metal compound forms an anion, such as ([B(C₆F₅)₃(X)]⁻), which stabilizes the cationic transition metal species generated by the reaction. The catalysts can be, and preferably are, prepared with activator components which are ionic compounds or compositions.

Compounds useful as an activator component in the preparation of the ionic catalyst systems used in the process of this invention comprise a cation, which is preferably a Bronsted acid capable of donating a proton, and a compatible non-coordinating anion which anion is relatively large (bulky), capable of stabilizing the active catalyst species (the Group 4 cation) which is formed when the two compounds are combined and said anion will be sufficiently labile to be displaced by olefinic, diolefinic and acetylenically unsaturated substrates or other neutral Lewis bases such as ethers, amines and the like. Two classes of compatible non-coordinating anions have been disclosed in European Publication Nos. EP 0 277 003 A and EP 0 277 004 A, published 1988: 1) anionic coordination complexes comprising a plurality of lipophilic radicals covalently coordinated to and shielding a central charge-bearing metal or metalloid core, and 2) anions comprising a plurality of boron atoms such as carboranes, metallocarboranes and boranes.

In a preferred embodiment, the stoichiometric activators include a cation and an anion component, and may be represented by the following formula:

(L-H)_{d}⁺(A^{d-}) (14)

wherein L is a neutral Lewis base; H is hydrogen; (L-H)⁺ is a Bronsted acid; A^{d-} is a non-coordinating anion having the charge d-; and d is 1 2, or 3.

The cation component, (L-H)d+ may include Bronsted acids such as protonated Lewis bases capable of protonating a moiety, such as an alkyl or aryl, from the bulky ligand metallocene containing transition metal catalyst precursor, resulting in a cationic transition metal species.

The activating cation (L-H)_{d}⁺ may be a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxoniums from ethers such as dimethyl ether diethyl ether, tetrahydrofuran and dioxane, sulfoniums from thioethers, such as diethyl thioethers and tetrahydrothiophene, and mixtures thereof.

The anion component A^{d-} include those having the formula [M^{k+}Qₙ]^{d-} wherein k is 1, 2, or 3; n is 2, 3, 4, 5, or 6; n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group having 1 to 20 carbon atoms, more preferably each Q is a fluorinated aryl group, and most preferably each Q is a pentafluoryl aryl group. Examples of suitable A^{d-} also include diboron compounds as disclosed in U.S. Pat. No. 5,447,895.

Illustrative, but not limiting examples of boron compounds which may be used as an activating cocatalyst in the preparation of the catalyst system of the processes of this invention are tri-substituted ammonium salts such as: trimethylammonium tetrakis(perfluoronaphthyl)borate, N,N-dimethyl anilinium tetrakis(heptafluoro-2-naphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, [4-t-butyl-PhNMe₂H][(C₆F₃(C₆F₅)₂)₄B], (where Ph is phenyl, and Me is methyl).

Most preferably, the ionic stoichiometric activator (L-H)_{d}⁺ (A^{d-}) is, N,N-dimethylanilinium tetrakis(perfluoronaphthyl)borate, N,N-dimethyl anilinium tetrakis(heptafluoro-2-naphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetrakis(perfluorophenyl)borate.

### Uses of Vinyl Terminated Polymers

The vinyl terminated oligomers or polymers prepared herein may be functionalized by reacting a heteroatom containing group with the allyl group of the polymer, with or without a catalyst. Examples include catalytic hydrosilylation, hydroformylation, hydroboration, epoxidation, hydration, dihydroxylation, hydroamination, or maleation with or without activators such as free radical generators (e.g., peroxides).

In some embodiments the vinyl terminated polymers produced herein are functionalized as described in U.S. Pat. No. 6,022,929; A. Toyota, T. Tsutsui, and N. Kashiwa, Polymer Bulletin 48, pp. 213-219, 2002; J. Am. Chem. Soc., 1990, 112, pp. 7433-7434; and U.S. patent application Ser. No. 12/487,739 filed on Jun. 19, 2009 (Published as PCT Publication No. WO 2009/155472).

The functionalized polymers can be used in oil additives and many other applications. Preferred uses include additives for lubricants and/or fuels. Preferred heteroatom containing groups include, amines, aldehydes, alcohols, acids, succinic acid, maleic acid, and maleic anhydride.

In particular embodiments herein, the vinyl terminated polymers disclosed herein, or functionalized analogs thereof, are useful as additives. In some embodiments, the vinyl terminated polymers disclosed herein, or functionalized analogs thereof, are useful as additives to a lubricant. Particular embodiments relate to a lubricant comprising the vinyl terminated polymers disclosed herein, or functionalized analogs thereof.

In other embodiments, the vinyl terminated polymers disclosed herein may be used as monomers for the preparation of polymer products. Processes that may be used for the preparation of these polymer products include coordinative polymerization and acid-catalyzed polymerization. In some embodiments, the polymeric products may be homopolymers. For example, if a vinyl terminated polymer (A) were used as a monomer, it is possible to form a homopolymer product with the formulation (A)ₙ, where n is the degree of polymerization.

In other embodiments, the polymer products formed from mixtures of monomer vinyl terminated polymers may be mixed polymers, comprising two or more repeating units that are different from each. For example, if a vinyl terminated polymer (A) and a different vinyl terminated polymer (B) were copolymerized, it is possible to form a mixed polymer product with the formulation (A)ₙ(B)ₘ, where n is the number of molar equivalents of vinyl terminated polymer (A) and m is the number of molar equivalents of vinyl terminated polymer (B) that are present in the mixed polymer product.

In yet other embodiments, polymer products may be formed from mixtures of the vinyl terminated polymer with another alkene. For example, if a vinyl terminated polymer (A) and alkene (B) were copolymerized, it is possible to form a mixed polymer product with the formulation (A)ₙ(B)ₘ, where n is the number of molar equivalents of vinyl terminated polymer and m is the number of molar equivalents of alkene that are present in the mixed polymer product.

In another embodiment, this invention relates to a functionalized polyolefin comprising the reaction product of a heteroatom containing group and any vinyl terminated polyolefin described herein, preferably where the functional group comprises one or more heteroatoms selected from the group consisting of P, O, S, N, Br, Cl, F, I, and/or B, and the functionalized polyolefin has 0.60 to 1.2, alternately, 0.75 to 1.10, functional groups per chain (preferably assuming that Mn has not altered by more than 15% as compared to the Mn of the vinyl terminated polyolefin prior to functionalization and optional derivatization). Number of functional groups per chain=F/Mn, is determined by ¹H NMR as described in PCT Publication No. WO 2009/155472. (See pages 26 to 27, paragraphs [00111] to [00114], including that VDRA is VRDA, which is the normalized integrated signal intensity for the vinylidene resonances between from about 4.65 to 4.85 ppm and the vinylene resonances at from about 5.15 to 5.6 ppm.) Preferred heteroatom containing group comprise one or more of sulfonates, amines, aldehydes, alcohols, or acids, preferably the heteroatom containing group comprises an epoxide, succinic acid, maleic acid, or maleic anhydride, alternately the heteroatom containing group comprises one or more of acids, esters, anhydrides, acid-esters, oxycarbonyls, carbonyls, formyls, formylcarbonyls, hydroxyls, and acetyl halides.

Percent functionalization of the polyolefin=(F*100)/(F+VI+VE), wherein VI is the number of vinyl groups/1000 carbons and VE is number of vinylidene groups/1000 Carbons for the unfunctionalized oligomer, VI* is the number of vinyl groups/1000 carbons and VE* is the number of vinylidene groups/1000 carbons for the functionalized oligomer, and F is the number of functional groups per 1000 carbons. The number of vinyl groups/1000 carbons (VI*) and number of vinylidene groups/1000 carbons (VE*) for the functionalized polyolefin are determined from the ¹H NMR spectra of the functionalized polyolefin in the same manner as VI and VE for the unfunctionalized polymer. Preferably, the percent functionalization of the polyolefin is 75% or more, preferably 80% or more, preferably 90% or more, preferably 95% or more. Further, preferably F+VI*+VE*≧(0.80(VI+VE)).

In another embodiment, the functionalized polyolefins described herein have the same Mn, and/or Mw, and/or Mz, or up to 15% greater than (preferably up to 10% greater than), as the starting vinyl terminated polyolefins, “same” is defined to mean plus or minus 5%.

In another embodiment, the vinyl terminated polyolefins described herein can be used in any process, blend or product disclosed in PCT Publication No. WO 2009/155472, which is incorporated by reference herein.

### Examples

In conducting the ¹³C NMR investigations, samples were dissolved in tetrachloroethane-d2 at concentrations between 10 to 15 wt % in a 10 mm NMR tube. ¹³C NMR data was collected at 120° C. using a Varian spectrometer with a ¹H frequency of at least 400 MHz. A 90 degree pulse, an acquisition time adjusted to give a digital resolution between 0.1 and 0.12 Hz, at least a 10 second pulse acquisition delay time with continuous broadband proton decoupling using swept square wave modulation without gating was employed during the entire acquisition period. The spectra were acquired using time averaging to provide a signal to noise level adequate to measure the signals of interest. Prior to data analysis spectra were referenced by setting the chemical shift of the TCE signal to 74.26 ppm.

The number of vinyl chain ends, vinylidene chain ends and vinylene chain ends is determined using ¹H NMR using deuterated tetrachloroethane as the solvent on an at least 250 MHz NMR spectrometer, and in selected cases, confirmed by ¹³C NMR. Proton NMR data was collected at either room temperature or 120° C. (for purposes of the claims, 120° C. shall be used) in a 5 mm probe using a Varian spectrometer with a ¹H frequency of at least 400 MHz. Data was recorded using a maximum pulse width of 45° C., 8 seconds between pulses and signal averaging 120 transients. Spectral signals were integrated and the number of unsaturation types per 1000 carbons was calculated by multiplying the different groups by 1000 and dividing the result by the total number of carbons. The number averaged molecular weight (Mn) was calculated by dividing the total number of unsaturated species into 14,000, assuming one unsaturation per polyolefin chain.

The chemical shift regions for the olefin types are defined to be between the following spectral regions.

| Unsaturation type | Region (ppm) | Number of hydrogen per structure |
|---|---|---|
| Vinyl | 4.95~5.10 | 2 |
| Vinylidene | 4.70~4.84 | 2 |
| Vinylene | 5.31~5.55 | 2 |
| Trisubstituted | 5.11~5.30 | 1 |

The chain end unsaturations are measured as follows. The vinyl resonances of interest are between from about 5.0 to 5.1 ppm (VRA), the vinylidene resonances between from about 4.65 to 4.85 ppm (VDRA), the vinylene resonances from about 5.31 to 5.55 ppm (VYRA), the trisubstituted unsaturated species from about 5.11 to 5.30 ppm (TSRA) and the aliphatic region of interest between from about 0 to 2.1 ppm (IA). The number of vinyl groups/1000 Carbons is determined from the formula: (VRA*500)/((IA+VRA+VYRA+VDRA)/2)+TSRA). Likewise, the number of vinylidene groups/1000 Carbons is determined from the formula: (VDRA*500)/((IA+VRA+VYRA+VDRA)/2)+TSRA), the number of vinylene groups/1000 Carbons from the formula (VYRA*500)/((IA+VRA+VYRA+VDRA)/2)+TSRA) and the number of trisubstituted groups from the formula (TSRA*1000)/((IA+VRA+VYRA+VDRA)/2)+TSRA). VRA, VDRA, VYRA, TSRA and IA are the integrated normalized signal intensities in the chemical shift regions defined above.

Molecular weights (number average molecular weight (Mn), weight average molecular weight (Mw), and z-average molecular weight (Mz)) were determined using a Polymer Laboratories Model 220 high temperature GPC-SEC equipped with on-line differential refractive index (DRI), light scattering (LS), and viscometer (VIS) detectors. It used three Polymer Laboratories PLgel 10 m Mixed-B columns for separation using a flow rate of 0.54 ml/min and a nominal injection volume of 300 μL. The detectors and columns were contained in an oven maintained at 135° C. The stream emerging from the SEC columns was directed into the miniDAWN optical flow cell and then into the DRI detector. The DRI detector was an integral part of the Polymer Laboratories SEC. The viscometer was inside the SEC oven, positioned after the DRI detector. The details of these detectors as well as their calibrations have been described by, for example, T. Sun, P. Brant, R. R. Chance, and W. W. Graessley, in Macromolecules, Volume 34, Number 19, pp. 6812-6820, (2001), incorporated herein by reference.

Solvent for the SEC experiment was prepared by dissolving 6 grams of butylated hydroxy toluene as an antioxidant in 4 liters of Aldrich reagent grade 1,2,4-trichlorobenzene (TCB). The TCB mixture was then filtered through a 0.7 μm glass pre-filter and subsequently through a 0.1 μm Teflon filter. The TCB was then degassed with an online degasser before entering the SEC. Polymer solutions were prepared by placing dry polymer in a glass container, adding the desired amount of TCB, then heating the mixture at 160° C. with continuous agitation for about 2 hours. All quantities were measured gravimetrically. The TCB densities used to express the polymer concentration in mass/volume units were 1.463 g/mL at room temperature and 1.324 g/mL at 135° C. The injection concentration was from 1.0 to 2.0 mg/mL, with lower concentrations being used for higher molecular weight samples. Prior to running each sample the DRI detector and the injector were purged. Flow rate in the apparatus was then increased to 0.5 mL/minute, and the DRI was allowed to stabilize for 8 to 9 hours before injecting the first sample. The concentration, c, at each point in the chromatogram was calculated from the baseline-subtracted DRI signal, I_{DRI}, using the following equation:

K_{DRI}I_{DRI}/(dn/dc)

where K_{DRI} is a constant determined by calibrating the DRI, and (dn/dc) is the refractive index increment for the system. The refractive index, n=1.500 for TCB at 135° C. and λ=690 nm. For purposes of this invention and the claims thereto (dn/dc)=0.104 for propylene polymers and 0.1 otherwise. Units of parameters used throughout this description of the SEC method are: concentration is expressed in g/cm³, molecular weight is expressed in g/mol, and intrinsic viscosity is expressed in dL/g.

The light scattering detector was a high temperature miniDAWN (Wyatt Technology, Inc.). The primary components are an optical flow cell, a 30 mW, 690 nm laser diode light source, and an array of three photodiodes placed at collection angles of 45°, 90°, and 135°. The molecular weight, M, at each point in the chromatogram was determined by analyzing the LS output using the Zimm model for static light scattering (M.B. Huglin, “Light Scattering from Polymer Solutions”, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the DRI analysis, A₂ is the second virial coefficient (for purposes of this invention, A₂=0.0006 for propylene polymers, 0.0015 for butene polymers and 0.001 otherwise), (dn/dc)=0.104 for propylene polymers, 0.098 for butene polymers and 0.1 otherwise, P(0) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 135° C. and λ=690 nm.

A high temperature viscometer from Viscotek Corporation was used to determine specific viscosity. The viscometer has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer was calculated from their outputs. The intrinsic viscosity, [η], at each point in the chromatogram was calculated from the following equation:

ηₛ=c[η]+0.3(c[η])²

where c is concentration and was determined from the DRI output.

The branching index (g′ᵥᵢₛ) is defined as the ratio of the intrinsic viscosity of the branched polymer to the intrinsic viscosity of a linear polymer of equal molecular weight and same composition, and was calculated using the output of the SEC-DRI-LS-VIS method as follows. The average intrinsic viscosity, [η]_{avg}, of the sample was calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined as:

$${g}_{vis}^{′} = \frac{{[ η ]}_{avg}}{{kM}_{v}^{α}}$$

The intrinsic viscosity of the linear polymer of equal molecular weight and same composition was calculated using Mark-Houwink equation. For purpose of this invention and claims thereto, α=0.695 and k=0.000579 for linear ethylene polymers, α=0.705 k=0.000262 for linear propylene polymers. Mᵥ is the viscosity-average molecular weight based on molecular weights determined by LS analysis. See Macromolecules, 2001, 34, pp. 6812-6820 and Macromolecules, 2005, 38, pp. 7181-7183, for guidance on selecting a linear standard having similar molecular weight and comonomer content, and determining k coefficients and a exponents. The molecular weight data reported here are those determined using GPC DRI detector, unless otherwise noted.

Viscosity was measured using a Brookfield Viscometer according to ASTM D-3236.

Bromine number is determined by ASTM D 1159.

Peak melting point, Tm, (also referred to as melting point), peak crystallization temperature, Tc, (also referred to as crystallization temperature), glass transition temperature (Tg), heat of fusion (ΔHf), and percent crystallinity were determined using the following DSC procedure according to ASTM D3418-03. Differential scanning calorimetric (DSC) data were obtained using a TA Instruments model Q200 machine. Samples weighing approximately 5-10 mg were sealed in an aluminum hermetic sample pan. The DSC data were recorded by first gradually heating the sample to 200° C. at a rate of 10° C./minute. The sample was kept at 200° C. for 2 minutes, then cooled to −90° C. at a rate of 10° C./minute, followed by an isothermal for 2 minutes and heating to 200° C. at 10° C./minute. Both the first and second cycle thermal events were recorded. Areas under the endothermic peaks were measured and used to determine the heat of fusion and the percent of crystallinity. The percent crystallinity is calculated using the formula, [area under the melting peak (Joules/gram)/B (Joules/gram)]*100, where B is the heat of fusion for the 100% crystalline homopolymer of the major monomer component. These values for B are to be obtained from the Polymer Handbook, Fourth Edition, published by John Wiley and Sons, New York 1999, provided however that a value of 189 J/g (B) is used as the heat of fusion for 100% crystalline polypropylene, a value of 290 J/g is used for the heat of fusion for 100% crystalline polyethylene. The melting and crystallization temperatures reported here were obtained during the second heating/cooling cycle unless otherwise noted.

All of the examples were produced in a 1-liter Autoclave reactor operated in the continuous stirred-tank solution process. The autoclave reactor was equipped with a stirrer, a water-cooling/steam-heating element with a temperature controller, and a pressure controller. Solvents and propylene were first purified by passing through a three-column purification system. Purification columns were regenerated periodically whenever there was evidence of lower activity of polymerization.

Isohexane was used as a solvent. The solvent was fed into the reactor using a Pulsa pump and its flow rate was controlled by a mass flow controller. The compressed, liquefied propylene feed was controlled by a mass flow controller. The solvent and propylene were fed into a manifold first. The mixture of solvent and monomers were then chilled to about −15° C. by passing through a chiller prior to feeding into the reactor through a single tube. The collected samples were first air-dried in a hood to evaporate most of the solvent and unreacted propylene, and then dried in a vacuum oven at a temperature of about 90° C. for about 12 hours. The vacuum oven dried samples were weighed to obtain yields. Propylene conversion was calculated basing on the polymer yield and the amount of propylene fed into the reactor. Catalyst activity (also referred as to catalyst productivity) was calculated based the yield and the feed rate of catalyst (metallocene only). All the reactions were carried out at a gauge pressure of about 2.4 MPa.

Catalysts used in the following examples was dimethyl siliyl bis(2-methyl 3-propyl indenyl)hafnium dimethyl and the activator used was N,N-dimethyl anilinium tetrakis(heptafluoro-2-naphthyl)borate. The metallocene catalyst was preactivated with the activator at a molar ratio of about 1:1 in 900 ml of toluene. All catalyst solutions were kept in an inert atmosphere and fed into reactors using an ISCO syringe pump. Tri-n-octylaluminum (TNOAL) solution (available from Sigma Aldrich, Milwaukee, Wis.) was further diluted in isohexane and used as a scavenger. Scavenger feed rate was adjusted to maximize the catalyst efficiency. The detailed process condition and some analytical results are summarized in Table 1 and Table 2. The catalyst feed rate was adjusted to achieve the yield and propylene conversion. Example 9 is a comparative example showing the process condition effects on level of branching.

TABLE 1

| | Example # | | | |
|---|---|---|---|---|
| | 1 | 2 | 3 | 4 |
| Reaction temperature (° C.) | 75 | 83 | 83 | 83 |
| Propylene feed rate (g/min) | 27 | 27 | 27 | 27 |
| Isohexane feed rate (g/min) | 27.5 | 27.5 | 27.5 | 27.5 |
| Yield (g/min) | 22.5 | 20.1 | 23.295 | 21.615 |
| Conversion (%) | 83.3% | 74.4% | 86.3% | 80.1% |
| Catalyst productivity (kg product/kg | 33,756 | 30,156 | 34,949 | 43,230 |
| catalyst) | | | | |
| Propylene concentration in reactor | 8.27% | 12.68% | 6.79% | 9.86% |
| (wt %) | | | | |
| Oligomer/propylene in reactor (wt) | 4.988 | 2.906 | 6.299 | 4.025 |
| Oligomer concentration in reactor | 41.28% | 36.88% | 42.74% | 39.66% |
| (wt %) | | | | |
| Mn_DRI (g/mol) | 2064 | 1303 | 1221 | 1233 |
| Mn (¹H NMR) (g/mol) | 3009 | 1721 | 1726 | 1810 |
| MWD (Mw/Mn) | 3.29 | 3.02 | 3.04 | 3.04 |
| g′ᵥᵢₛ | 0.883 | 0.864 | 0.842 | 0.915 |
| Vinyl (%) | 96.39% | 96.46% | 95.24% | 97.09% |
| Vinylenes/1000 carbons | 0 | 0 | 0 | 0 |
| Trisubstituted olefin/1000 carbons | 0 | 0 | 0 | 0 |
| Vinyls/1000 carbons | 1 | 1 | 1 | 1 |
| Vinylidenes/1000 carbons | 0.0375 | 0.0367 | 0.05 | 0.03 |
| Glass transition temperature (° C.) | −14.75 | −18.46 | −26.37 | 23.2 |

TABLE 2

| | Example # | | | | |
|---|---|---|---|---|---|
| | 5 | 6 | 7 | 8 | 9 |
| Reaction temperature (° C.) | 83 | 83 | 92 | 78 | 83 |
| Propylene feed rate (g/min) | 27 | 27 | 27 | 27 | 27 |
| Isohexane feed rate (g/min) | 27.5 | 27.5 | 27.5 | 27.5 | 27.5 |
| Yield (g/min) | 19.4 | 23.3 | 21.3 | 23.3 | 13.6 |
| Conversion (%) | 71.7% | 86.4% | 78.8% | 86.3% | 50.3% |
| Catalyst productivity (kg product/kg | 58,095 | 27,978 | 31,926 | 34,956 | 81,540 |
| catalyst) | | | | | |
| Propylene concentration in reactor (wt %) | 14.02% | 6.74% | 10.5% | 6.79% | 24.62% |
| Oligomer/propylene in reactor (wt) | 2.534 | 6.353 | 3.717 | 6.299 | 1.012 |
| Oligomer concentration in reactor (wt %) | 35.53% | 42.78% | 39.05% | 42.75% | 24.94% |
| Mn_DRI (g/mol) | 1286 | 1190 | 905 | 1898 | 1372 |
| Mn (¹H NMR) (g/mol) | 1838 | 1765 | 1089 | 2506 | 1915 |
| MWD (Mw/Mn) | 2.97 | 3.24 | 2.32 | 2.81 | 2.88 |
| g′ᵥᵢₛ | 0.925 | 0.862 | 0.877 | | 1.031 |
| Vinyl (%) | 97.09% | 96.15% | 96.73% | 97.40% | 98.04% |
| Vinylenes/1000 carbons | 0 | 0 | 0 | 0 | 0 |
| Trisubstituted olefin/1000 carbons | 0 | 0 | 0 | 0 | 0 |
| Vinyls/1000 carbons | 1 | 1 | 1.48 | 1.5 | 1 |
| Vinylidenes/1000 carbons | 0.03 | 0.04 | 0.05 | 0.04 | 0.02 |
| Glass transition temperature (° C.) | −21.79 | −23.64 | | −16.78 | −21.14 |

The propylene and oligomer concentrations in the reactor listed in Tables 1 and 2 were calculated assuming CSTR mode of operation for the oligomerization. The branching index, g′ᵥᵢₛ, was measured for selected samples and the results are listed in Tables 1 and 2. The value of g′ᵥᵢₛ varies from 0.842 to 0.925 for the inventive examples. The g′ᵥᵢₛ value is about 1.0 for the comparative Example 9. As demonstrated in the examples, branched propylene oligomers and polymers were obtained when the concentration ratio of oligomer to propylene is greater than 1.0.

Materials produced in Examples 1 to 9 were also subjected to DSC analysis. No detectable melting peak and crystallization peaks were observed. The glass transition temperatures are listed in Tables 1 and 2.

¹H NMR spectra were recorded for all samples. A summary of the concentrations of the olefin unsaturations is listed in Tables 1 and 2. The number average molecular weight of each sample was calculated from the ¹H NMR data assuming one unsaturation per chain, and in Tables 1 and 2 these values were compared with the number average molecular weights derived from GPC. A parity plot of Mn (¹H NMR) versus Mn (GPC-DRI) was observed from the data listed in Table 1 and 2. Departures from parity are thought to be due to contributions from long chain branching.

Products produced in Examples 1, 2, 7 and 8 were examined using ¹³C NMR. Results of the ¹³CNMR characterization are shown in the Table 3 below.

TABLE 3
¹³C NMR Results

| | | Saturated:Unsaturated | Avg Number LCB per |
|---|---|---|---|
| Example | m:r | End groups | Molecule |
| Example #1 | 0:44:0.56 | 0.70:0.30 | 0.75 |
| Example #2 | 0.44:0.56 | 0.67:0.33 | 0.61 |
| Example #7 | 0.41:0.59 | 0.72:0.28 | 0.59 |
| Example #8 | 0.44:0.56 | 0.68:0.32 | 0.64 |

The “propylene tacticity index”, expressed herein as [m:r], is calculated as defined in H. N. Cheng, Macromolecules, 17, p. 1950 (1984). As shown in the table above, [m:r] is about 1:1 for all four samples, indicating the atactic nature of the samples.

The viscosity profile for products made in Examples 1 and 2 are listed in Table 4. The viscosity was measured using a Brookfield viscometer according to ASTM D-3236.

TABLE 4
Viscosity profiles for products made in Examples #1 and #2

| Example #1 | | Example #2 | |
|---|---|---|---|
| | Viscosity | | Viscosity |
| Temperature (° C.) | (mPa · s) | Temperature (° C.) | (mPa · s) |
| 49.8 | 16,275 | 19.5 | 133,000 |
| 59.8 | 6,288 | 29.8 | 29,300 |
| 69.7 | 2,850 | 39.9 | 8,875 |
| 79.6 | 1,463 | 49.8 | 3,300 |
| | | 59.8 | 1,463 |

All documents described herein are incorporated by reference herein for purposes of all jurisdictions where such practice is allowed, including any priority documents, related application and/or testing procedures to the extent they are not inconsistent with this text, provided however that any priority document not named in the initially filed application or filing documents is NOT incorporated by reference herein.

1. A branched amorphous propylene polymer comprising:
at least 95 mol % propylene and 0 to 5 mol % vinyl monomer,
wherein the polymer has a g′ᵥᵢₛ of less than 0.98;
an Mₙ of about 200 to about 20,000 g/mol;
a heat of fusion of less than 10 J/g; and
has greater than 50% allylic chain end functionality.

2. The amorphous polymer of claim 1, wherein the g′ᵥᵢₛ is less than 0.95.

3. The amorphous polymer of claim 1, wherein the g′ᵥᵢₛ is less than 0.90.

4. The amorphous polymer of claim 1, wherein Mₙ is from about 500 to about 10,000 g/mol.

5. The amorphous polymer of claim 1, wherein the ratio of percentage of saturated chain ends to percentage of allyl chain is greater than 1.

6. The amorphous polymer of claim 1, wherein the heat of fusion is less than about 5 J/g.

7. The amorphous polymer of claim 1, wherein the ratio of Mn(GPC)/Mn(¹H NMR) is less than 1.

8. The amorphous polymer of claim 1, wherein the amorphous polymer has greater than 60% allylic chain end functionality.

9. The amorphous polymer of claim 1, wherein the amorphous polymer has greater than 70% allylic chain end functionality.

10. The amorphous polymer of claim 1, wherein the amorphous polymer has greater than 90% allylic chain end functionality.

11. The amorphous polymer of claim 1, wherein the amorphous polymer has greater than 95% allylic chain end functionality.

12. The amorphous polymer of claim 1, wherein the Tₘ of the amorphous polymer is not measureable by DSC.

13. A process for the preparation of the branched amorphous polymer of claim 1, wherein the process comprises:
contacting propylene, under polymerization conditions, with at least a catalyst system comprising an activator and at least one metallocene; and
obtaining a branched propylene polymer having at least 50% allyl chain ends (relative to total unsaturations) and a g′ᵥᵢₛ of 0.98 or less.

14. The process of claim 13, wherein the process is a solution process.

15. The process of claim 13, wherein the catalyst system further comprises a co-activator.

16. The process of claim 13, wherein the activator is a non-coordinating anion comprising boron.

17. The process of claim 16, wherein the bulky activator is one or more of: trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, [4-t-butyl-PhNMe₂H][(C₆F₃(C₆F₅)₂)₄B], (where Ph is phenyl, and Me is methyl).

18. The process of claim 13, further comprising contacting a comonomer with the propylene and catalyst system, wherein a branched vinyl terminated propylene copolymer is produced, and wherein the amorphous propylene copolymer has a comonomer content in the range of 0.01 to 5 mol %.

19. The process of claim 18, wherein the comonomer is ethylene.

20. The process of claim 13, wherein the metallocene compound is one or more of:
rac-dimethylsilyl bis(2-methyl,3-propylindenyl)hafniumdimethyl,
rac-dimethylsilyl bis(2-methyl,3-propylindenyl)zirconiumdimethyl,
rac-dimethylsilyl bis(2-ethyl,3-propylindenyl)hafniumdimethyl,
rac-dimethylsilyl bis(2-ethyl,3-propylindenyl)zirconiumdimethyl,
rac-dimethylsilyl bis(2-methyl,3-ethylindenyl)hafniumdimethyl,
rac-dimethylsilyl bis(2-methyl,3-ethylindenyl)zirconiumdimethyl,
rac-dimethylsilyl bis(2-methyl,3-isopropylindenyl)hafniumdimethyl,
rac-dimethylsilyl bis(2-methyl,3-isopropylindenyl)zirconiumdimethyl,
rac-dimethylsilyl bis(2-methyl,3-butyllindenyl)hafniumdimethyl,
rac-dimethylsilyl bis(2-methyl,3-butylindenyl)zirconiumdimethyl,
rac-dimethylgermanyl bis(2-methyl,3-propylindenyl)hafniumdimethyl,
rac-dimethylgermanyl bis(2-methyl,3-propylindenyl)zirconiumdimethyl,
rac-dimethylgermanyl bis(2-ethyl,3-propylindenyl)hafniumdimethyl,
rac-dimethylgermanyl bis(2-ethyl,3-propylindenyl)zirconiumdimethyl,
rac-dimethylgermanyl bis(2-methyl,3-ethylindenyl)hafniumdimethyl,
rac-dimethylgermanyl bis(2-methyl,3-ethylindenyl)zirconiumdimethyl,
rac-dimethylgermanyl bis(2-methyl,3-isopropylindenyl)hafniumdimethyl,
rac-dimethylgermanyl bis(2-methyl,3-isopropylindenyl)zirconiumdimethyl,
rac-dimethylgermanyl bis(2-methyl,3-butyllindenyl)hafniumdimethyl,
rac-dimethylgermanyl bis(2-methyl,3-propylindenyl)zirconiumdimethyl,
rac-dimethylsilyl bis(2-propyl,3-methylindenyl)hafniumdimethyl,
rac-dimethylsilyl bis(2-propyl,3-methylindenyl)zirconiumdimethyl,
rac-dimethylsilyl bis(2-propyl,3-ethylindenyl)hafniumdimethyl,
rac-dimethylsilyl bis(2-propyl,3-ethylindenyl)zirconiumdimethyl,
rac-dimethylsilylbis(2-propyl,3-butylindenyl)hafniumdimethyl,
rac-dimethylsilylbis(2-propyl,3-butylindenyl)zirconiumdimethyl,
rac-dimethylsilyl bis(2-methyl,3-butylindenyl)hafniumdimethyl,
rac-dimethylsilyl bis(2-methyl,3-butylindenyl)zirconiumdimethyl,
rac-dimethylsilyl bis(2,3-dimethyl)hafniumdimethyl,
rac-dimethylsilyl bis(2,3-dimethyl)zirconiumdimethyl,
rac-dimethylgermanyl bis(2-propyl,3-methylindenyl)hafniumdimethyl,
rac-dimethylgermanyl bis(2-propyl,3-methylindenyl)zirconiumdimethyl,
rac-dimethylgermanyl bis(2-propyl,3-ethylindenyl)hafniumdimethyl,
rac-dimethylgermanyl bis(2-propyl,3-ethylindenyl)zirconiumdimethyl,
rac-dimethylgermanyl bis(2-propyl,3-butylindenyl)hafniumdimethyl,
rac-dimethylgermanyl bis(2-propyl,3-butylindenyl)zirconiumdimethyl,
rac-dimethylgermanyl bis(2-methyl,3-butylindenyl)hafniumdimethyl,
rac-dimethylgermanyl bis(2-methyl,3-butylindenyl)zirconiumdimethyl,
rac-dimethylgermanyl bis(2,3-dimethyl)hafniumdimethyl, and
rac-dimethylgermanyl bis(2,3-dimethyl)zirconiumdimethyl.

21. The process of claim 13, where the metallocene is a hafnocene, the activator is dimethylaniliniumtetrakis(perfluoronaphthyl)borate, dimethylaniliniumtetrakis(perfluorobiphenyl)borate, or [4-t-butyl-PhNMe₂H][(C₆F₃(C₆F₅)₂)₄B], (where Ph is phenyl, and Me is methyl) and the catalyst system has an catalyst productivity greater than 20,000 kg polymer per kg catalyst.

22. The process of claim 13, wherein the conversion of propylene to branched amorphous polymer is at least 50%.

23. The process of claim 13, wherein the conversion of propylene to branched amorphous polymer is at least 60%.

24. The process of claim 13, wherein the molar ratio of vinyl monomer concentration to propylene concentration is at least 1.2.

25. The process of claim 13, wherein the catalyst activity is at least 10,000 kg polymer per kg catalyst in a continuous process.
